(19) United States
(12) Patent Application Publication
(10) Pub. No.: US 2026/0319190 A1
(43) Pub. Date: Oct. 15, 2026

(54) BACKPLANE OPTICAL FIBER CONNECTION SYSTEM

(71) Applicant: Senko Advanced Components, Inc., Hudson, MA (US)

(72) Inventors: Shota MIZUKI, Tokyo (JP); Kenji IIZUMI, Tokyo (JP); Kazuyoshi TAKANO, Tokyo (JP)

(21) Appl. No.: 19/647,437

(22) Filed: Apr. 14, 2026

Related U.S. Application Data
(60) Provisional application No. 63/788,775, filed on Apr. 14, 2025.

(51) Int. Cl. G02B 6/40; G02B 6/38

(52) U.S. Cl. CPC G02B 6/406; G02B 6/3849; G02B 6/3883

(57) ABSTRACT

In a backplane optical fiber connection system, two mating connector assemblies have shutters. During mating, the first shutter opens before the second shutter. The two mating connector assemblies of a backplane optical fiber connection system can include a stationary connector assembly and a floating connector assembly. Floating inner connector units are received in a floating outer housing assembly, each with a ferrule and a ferrule spring. A float spring is loaded between first and second housing members of the floating outer housing assembly. The at least one float spring has a cumulative spring force greater than the aggregate ferrule spring force. A floating outer housing assembly can include a trailing housing member, a central housing member, and a slide fixture connected to the trailing housing member in spring-loaded relation. The central housing member has at least three degrees of freedom of movement relative to the slide fixture.

### CROSS-REFERENCE TO RELATED APPLICATIONS

This application claims priority to U.S. Provisional Patent Application No. 63/788,775, filed Apr. 14, 2025, which is hereby incorporated by reference in its entirety.

### FIELD

The present disclosure relates to fiber optic connectors for network equipment, and more particularly to a backplane optical fiber connection system having blind mate capability with floating alignment and sequential shutter actuation.

### BACKGROUND

Optical communications are increasingly used in systems to achieve data communication with greater bandwidth and lower electromagnetic interference as compared to electrical communications. Optical fibers may be employed for optical input/output and may be coupled to other optical fibers and system components by optical connectors. In data center environments, telecommunications infrastructure, and other network equipment applications, fiber optic connections are commonly made between equipment modules and a backplane or mid-plane circuit board to facilitate high-speed data transfer.

Optical transmission systems may be employed to interconnect network elements within such equipment. Optical connectors include optical fibers that may be connected end-to-end to transfer light or optical power therebetween. The fibers may be terminated in connector assemblies and may be mated by an adapter or directly to one another. Some optical connection systems include blind-mating arrangements in which connector assemblies are brought together without direct visual access to the mating interface, such as when an equipment module is inserted into a chassis and must connect to a backplane-mounted connector.

In electronic module enclosure arrangements, an optical module may be coupled to another optical component via an optical blind-mate adapter. Air flow leakage, however, may tend to occur, particularly when no optical modules are connected to an adapter of the mid-plane or when only one optical module is connected to an adapter. In addition, adapter openings may allow dust to infiltrate the system or accumulate onto an optical fiber contact end when an optical module is absent on the other side of the adapter. Furthermore, there may be eye safety considerations for human operators when an optical module is absent on the other side of an adapter. Shutters have been employed in optical connectors and adapters to provide air flow management, dust management, and eye safety by restricting airflow, dust, and light through the adapter when optical modules are not fully connected.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In one aspect, a backplane optical fiber connection system comprises a first connector assembly including a first outer housing. A plurality of first inner connector units are received in the first outer housing. Each first inner connector unit includes a ferrule. A first shutter is movable between a closed position and an open position. A second connector assembly is configured to mate with the first connector assembly. The second connector assembly includes a second outer housing. A plurality of second inner connector units are received in the second outer housing. Each second inner connector unit includes a ferrule. A second shutter is movable between a closed position and an open position. The first connector assembly and the second connector assembly are configured such that, during a mating operation in which the first connector assembly and the second connector assembly are brought together to establish an optical connection between the ferrules of the first inner connector units and the ferrules of the second inner connector units, the first shutter moves from the closed position to the open position before the second shutter moves from the closed position to the open position.

In another aspect, a backplane optical fiber connection system for making a blind mate optical connection to a backplane of fiber optic network equipment comprises a stationary connector assembly configured to be mounted adjacent the backplane of the fiber optic network equipment. The stationary connector assembly comprises a stationary outer housing. A plurality of stationary inner connector units are received in the stationary outer housing. Each stationary inner connector unit includes a ferrule. A floating connector assembly is configured to mate with the stationary connector assembly. The floating connector assembly includes a floating outer housing assembly including a first housing member and a second housing member. The second housing member is movable relative to the first housing member along a mating axis to provide float along the mating axis. A plurality of floating inner connector units are received in the floating outer housing assembly. Each floating inner connector unit includes a ferrule and a ferrule spring biasing the ferrule in a direction along the mating axis. The ferrule springs of the plurality of floating inner connector units have an aggregate ferrule spring force. At least one float spring is loaded between the first housing member and the second housing member. The at least one float spring has a cumulative spring force greater than the aggregate ferrule spring force. The at least one float spring biases the second housing member toward the stationary connector assembly such that the ferrule springs of the plurality of floating inner connector units remain loaded when the stationary connector assembly and the floating connector assembly are in a mated state.

In another aspect, a backplane optical fiber connection system comprises a stationary connector assembly including a stationary outer housing and a plurality of stationary inner connector units received in the stationary outer housing. A floating connector assembly is configured to mate with the stationary connector assembly by movement toward the stationary connector along a mating axis. The floating connector assembly includes a floating outer housing assembly comprising a trailing housing member. A central housing member is connected to the trailing housing member by floating fasteners that permit the central housing member to move relative to the trailing housing member in a plane perpendicular to the mating axis. At least one slide fixture is connected to the trailing housing member in spring-loaded relation by at least one float spring that permits the trailing housing member to move relative to the slide fixture along the mating axis. The central housing member has at least three degrees of freedom of movement relative to the slide fixture including movement along the mating axis, movement along a lateral axis perpendicular to the mating axis, and movement along a transverse axis perpendicular to both the mating axis and the first lateral axis.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is a perspective of a backplane connection system showing a stationary connector assembly and a floating connector assembly thereof in a disconnected configuration;

FIG. 2 is another perspective of the backplane connection system in the disconnected configuration;

FIG. 3 is a side elevation of the backplane connection system in the disconnected configuration;

FIG. 4 is a plan view of the backplane connection system in the disconnected configuration;

FIG. 5 is a plan view of the stationary connector assembly;

FIG. 6 is a leading end elevation of the stationary connector assembly;

FIG. 7 is a trailing end elevation of the stationary connector assembly;

FIG. 8 is a cross section taken in the plane of line 8-8 of FIG. 7;

FIG. 9 is an exploded perspective of the stationary connector assembly;

FIG. 10 is a perspective of a stationary outer housing of the stationary connector assembly;

FIG. 11 is another perspective of the stationary outer housing;

FIG. 12 is a leading end elevation of the stationary outer housing;

FIG. 13 is a cross section taken in the plane of line 13-13 of FIG. 12;

FIG. 14 is a perspective of a slider of the stationary connector assembly;

FIG. 15 is another perspective of the slider;

FIG. 16 is a fragmentary cross section taken in the plane of line 16-16 of FIG. 6;

FIG. 17 is a perspective showing a subassembly of the stationary connector assembly including the sliders and a pair of shutter plates connected thereto;

FIG. 18 is a cross section taken in the plane of line 18-18 of FIG. 6;

FIG. 19 is a perspective of a stationary inner connector unit of the stationary connector assembly;

FIG. 20 is another perspective of the stationary inner connector unit;

FIG. 21 is an exploded perspective of the stationary inner connector unit;

FIG. 22 is a leading end elevation of the stationary inner connector unit;

FIG. 23 is a plan view of the stationary inner connector unit;

FIG. 24 is a cross section taken in the plane of line 24-24 of FIG. 22;

FIG. 25 is a perspective of an alternative embodiment of a stationary inner connector unit for a stationary connector assembly;

FIG. 26 is a cross section similar to FIG. 24 but showing the stationary inner connector unit of FIG. 25;

FIG. 27 is a perspective of the floating connector assembly;

FIG. 28 is a plan view of the floating connector assembly;

FIG. 29 is a leading end elevation of the floating connector assembly;

FIG. 30 is a trailing end elevation of the floating connector assembly;

FIG. 31 is a cross section taken in the plane of line 31-31 of FIG. 30;

FIG. 32 is an exploded perspective of the floating connector assembly;

FIG. 33 is a perspective of a floating inner connector unit of the floating connector assembly;

FIG. 34 is another perspective of the floating inner connector unit;

FIG. 35 is a leading end elevation of the floating inner connector unit;

FIG. 36 is a plan view of the floating inner connector unit;

FIG. 37 is a side elevation of the floating inner connector unit;

FIG. 38 is a cross section taken in the plane of line 38-38 of FIG. 37;

FIG. 39 is an exploded perspective of the floating inner connector unit;

FIG. 40 is a perspective of an alternative embodiment of a floating inner connector unit for a floating connector assembly;

FIG. 41 is a perspective of a floating outer housing assembly of the floating connector assembly;

FIG. 42 is a plan view of the floating outer housing assembly;

FIG. 43 is a leading end elevation of the floating outer housing assembly;

FIG. 44 is a trailing end elevation of the floating outer housing assembly;

FIG. 45 is an exploded perspective of the floating outer housing assembly;

FIG. 46 is a perspective of a trailing housing member of the floating outer housing assembly;

FIG. 47 is a perspective of a slide fixture of the floating outer housing assembly;

FIG. 48 is another perspective of the slide fixture;

FIG. 49 is a perspective of a central housing member of the floating outer housing assembly;

FIG. 50 is another perspective of the central housing member;

FIG. 51 is a perspective of a slider housing of the floating outer housing assembly;

FIG. 52 is another perspective of the slider housing;

FIG. 53 is a cross section taken in the plane of line 53-53 of FIG. 44;

FIG. 54 is a cross-sectional perspective of the floating outer housing assembly in which the cross section is taken in the same plane as FIG. 53;

FIG. 55 is a cross section taken in the plane of line 55-55 of FIG. 29;

FIG. 56 is a cross-sectional perspective of the floating connector assembly in which the cross section is taken in the same plane as FIG. 55;

FIG. 57 is an enlarged fragmentary perspective of a portion of the floating connector assembly with a double-ended arrow to indicate a floating range of motion of the central housing member with respect to the trailing housing member along the y-axis;

FIG. 58 is an enlarged fragmentary perspective similar to FIG. 57 showing the central housing member at one end of the floating range of motion along the y-axis;

FIG. 59 is an enlarged fragmentary perspective similar to FIGS. 57 and 58 showing the central housing member at an opposite end of the floating range of motion along the y-axis;

FIG. 60 is an enlarged fragmentary cross-sectional perspective of a portion of the floating connector assembly with a double-ended arrow to indicate a floating range of motion of the central housing member with respect to the trailing housing member along the x-axis;

FIG. 61 is a fragmentary perspective of a portion of the floating connector assembly showing the central housing member at one end of a floating range of motion along the x-axis with respect to the trailing housing member;

FIG. 62 is a fragmentary perspective similar to FIG. 61 showing the central housing member at an opposite end of the floating range of motion along the x-axis;

FIG. 63 is a cross section taken in the plane of line 63-63 of FIG. 42 and showing the central housing member at one corner position of its floating range of motion in the plane parallel to the x-axis and y-axis;

FIG. 64 is a cross section similar to FIG. 63 showing the central housing member at a diagonally opposite position of its floating range of motion in the plane parallel to the x-axis and y-axis;

FIG. 65 is an enlarged fragmentary cross-sectional perspective showing how the slide fixture is connected in spring-loaded relation to the trailing housing member;

FIG. 66 is a perspective of the floating connector assembly showing the floating outer housing assembly in a configuration in which the float springs are fully extended to bias the trailing housing member to a forward-most position along a z-axis range of floating motion in relation to the slide fixtures;

FIG. 67 is a perspective similar to FIG. 66 but showing the floating outer housing assembly in another configuration in which the float springs are compressed by the trailing housing member moving in relation to the slide fixtures to a rearward-most position along the z-axis range of motion;

FIG. 68 is a cross section taken in the plane of line 68-68 of FIG. 42 and showing the trailing housing member in the forward-most position along a z-axis range of motion;

FIG. 69 is a cross-sectional perspective of the floating outer housing assembly in which the cross section is taken in the same plane as FIG. 68 and the floating outer housing assembly is shown configured with the trailing housing member in the forward-most position along a z-axis range of motion;

FIG. 70 is a cross-sectional perspective similar to FIG. 69 in which the floating outer housing assembly is shown configured with the trailing housing member in the rearward-most position along a z-axis range of motion;

FIG. 71 is a cross section showing the floating connector assembly approaching the stationary connector assembly during initial stages of a mating sequence;

FIGS. 72A-72C are a series of fragmentary cross sections showing the floating connector assembly moving from the position in FIG. 71 to an initial engaged position and utilizing the x-axis floating range of motion to align itself in relation to the stationary connector assembly along the x-axis;

FIG. 73 is a fragmentary cross section showing the floating connector assembly approaching the stationary connector assembly during initial stages of a mating sequence;

FIG. 74 is an enlarged fragmentary perspective showing the floating connector assembly approaching the stationary connector assembly during initial stages of a mating sequence;

FIGS. 75A and 75B are a series of fragmentary cross sections showing the floating connector assembly moving from the position in FIG. 71 toward the stationary connector assembly prior to the opening of any shutter;

FIGS. 76A-76C are a series of fragmentary cross sections showing the floating connector assembly moving further toward the stationary connector assembly from the position in FIG. 75B, demonstrating how the floating connector assembly (i) opens the stationary connector shutter plates before opening floating connector shutter plates thereof and (ii) uses the y-axis floating range of motion to self-center in relation to the stationary connector assembly along the y-axis;

FIG. 77 is a cross-sectional perspective of the configuration of the backplane connection system shown in FIG. 76C;

FIGS. 78A and 78B are cross sections of a subassembly of the floating outer housing assembly showing operation of the slider housing thereof;

FIGS. 79A-79C are a series of fragmentary cross sections showing further insertion of the floating connector assembly from the position seen in FIGS. 76C and 77 and illustrating how the floating connector shutter plates open and an optical connection is made between the stationary inner connector units and the floating inner connector units after the floating outer housing assembly is aligned with the stationary outer housing assembly in an x-y plane and the stationary connector shutter plates have opened;

FIGS. 80A and 80B are plan views of the backplane connection system showing the sequence of a final stage of the connection process in which the float springs are loaded by movement of the trailing housing member relative to the slide fixtures whereby ferrules of the floating inner connector units are urged into intimate contact with ferrules of the stationary inner connector units; and

FIGS. 81A and 81B are cross sections of FIGS. 80A and 80B, respectively.

Reference numerals in the drawings correspond to like elements in the detailed description. Such reference numerals are used to facilitate an understanding of the disclosure and are not intended to be limiting.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

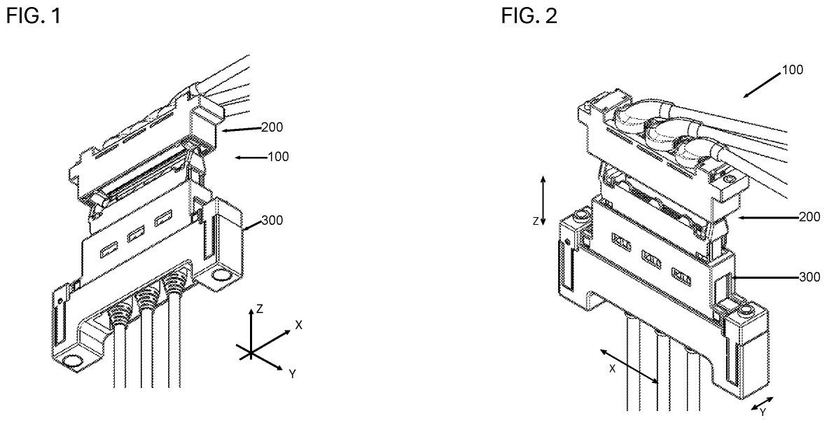

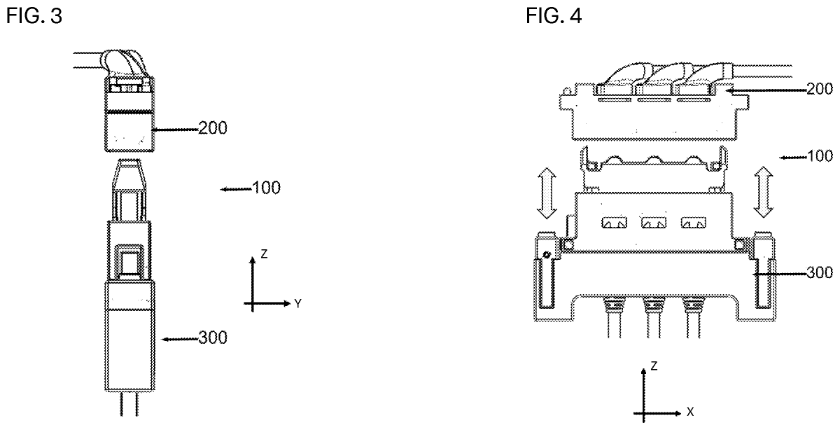

Referring to FIGS. 1-4, a backplane connection system 100 is configured for making blind mate optical connections in fiber optic network equipment. The backplane connection system 100 may be used in data center environments, telecommunications infrastructure, or other applications where high-density fiber optic connections are made between equipment modules and a backplane. The backplane connection system 100 comprises a stationary connector assembly 200 (broadly, a first connector assembly or backplane-mounted connector assembly) and a floating connector assembly 300 (broadly, a second connector assembly or chassis-mounted connector assembly) that are configured to blind mate to establish optical connections.

Throughout this disclosure, a coordinate system is used to describe the spatial relationships and movements of the various components. An x-axis extends along a lateral direction, a y-axis extends along a transverse direction perpendicular to the x-axis, and a z-axis extends along a mating axis perpendicular to both the x-axis and the y-axis. The mating axis corresponds to the direction along which the stationary connector assembly 200 and the floating connector assembly 300 are brought together during a mating operation. As used herein, the terms “leading” and “trailing” are used with reference to each individual connector assembly. The leading direction of each connector assembly is the direction along the z-axis toward the mating interface of that connector assembly, and the trailing direction is opposite the leading direction. When the stationary connector assembly 200 and the floating connector assembly 300 face each other in the mating configuration, the leading directions of the two connector assemblies are opposite to one another along the z-axis.

With continued reference to FIGS. 1-4, the stationary connector assembly 200 is configured to be mounted adjacent a backplane of fiber optic network equipment. In some cases, the stationary connector assembly 200 may be fixedly mounted to the backplane or to a structure associated with the backplane.

The floating connector assembly 300 is configured to mate with the stationary connector assembly 200 by movement toward the stationary connector assembly 200 along the mating axis (z-axis). As will be explained in further detail below, the floating outer housing assembly 310 comprises multiple housing members that enable the floating connector assembly 300 to move relative to a mounting structure in three degrees of freedom, including movement along the x-axis, movement along the y-axis, and movement along the z-axis. This three-axis floating capability provides blind mate compatibility, allowing the floating connector assembly 300 to self-align with the stationary connector assembly 200 during a mating operation even when there are positional variations between the two connector assemblies.

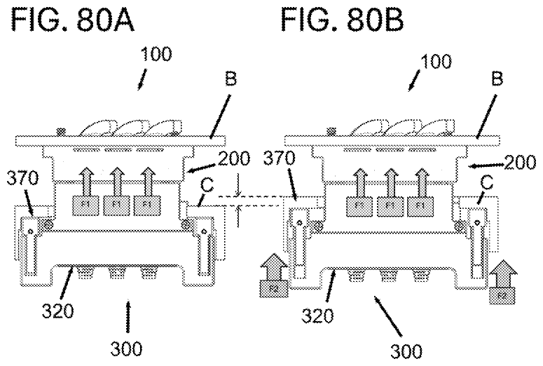

In one example application depicted in FIGS. 80A and 80B, the stationary connector assembly 200 is mounted to a backplane B and the floating connector assembly 300 is mounted to a chassis component C. In other embodiments, the mounting orientations may be reversed or otherwise varied, and the stationary connector assembly 200 may also include float capability.

As will be explained in further detail below, the backplane connection system 100 incorporates a sequential shutter actuation arrangement. During a mating operation, a stationary connector shutter on the stationary connector assembly 200 opens before a floating connector shutter on the floating connector assembly 300. This sequential shutter operation ensures that the ferrules of the inner connector units remain protected until proper alignment between the connector assemblies is achieved, minimizing exposure to dust and other contaminants that could degrade optical performance. The sequential shutter actuation arrangement cooperates with blind mating features of the backplane connection system to permit shutter actuation and self-alignment in sequence without interference.

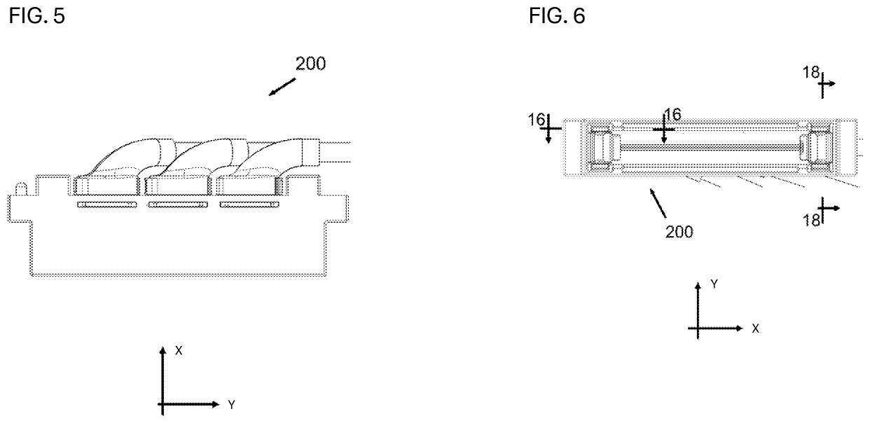

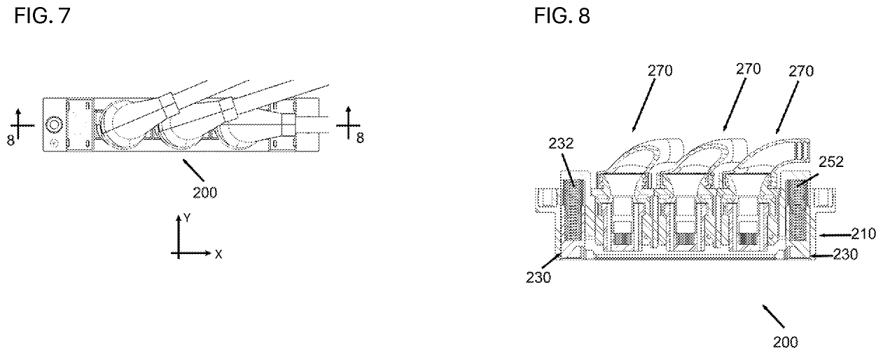

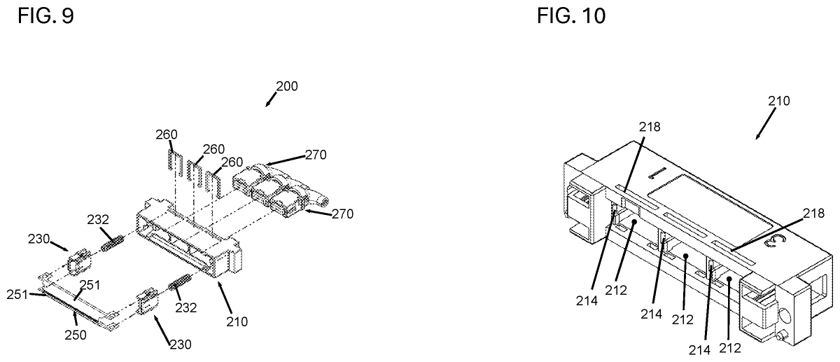

Referring to FIGS. 5-9, the stationary connector assembly 200 comprises a stationary outer housing 210 (broadly, first outer housing), a plurality of stationary inner connector units 270 (broadly, first inner connector units), a stationary connector shutter 250 (broadly, first shutter) comprising a pair of stationary connector shutter plates 251, a pair of sliders 230, a pair of slider springs 232, and a plurality of U-shaped retention clips 260. The stationary outer housing 210 provides the structural framework for the stationary connector assembly 200 and is configured to receive and organize the various components of the assembly. The plurality of stationary inner connector units 270 are received within the connector unit receptacles of the stationary outer housing 210. The stationary inner connector units 270 may be secured within the stationary outer housing 210 by the U-shaped retention clips 260. As will be explained in further detail below, the sliders 230 are configured to control actuation of the shutter and also to guide floating alignment of the floating connector assembly 300 with the stationary connector assembly 200 during mating. The pair of stationary connector shutter plates 251 are connected to the sliders 230 and are configured to cover the stationary inner connector units 270 when in a closed position. The connection between the stationary connector shutter plates 251 and the sliders 230 is such that movement of the sliders 230 drives corresponding movement of the stationary connector shutter plates 251. When the sliders 230 are pushed rearward against the bias of the slider springs 232, the stationary connector shutter plates 251 move from the closed position to an open position to expose the ferrules of the stationary inner connector units 270.

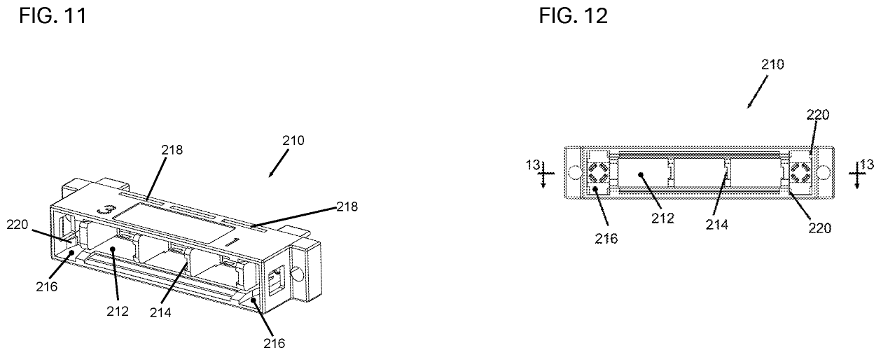

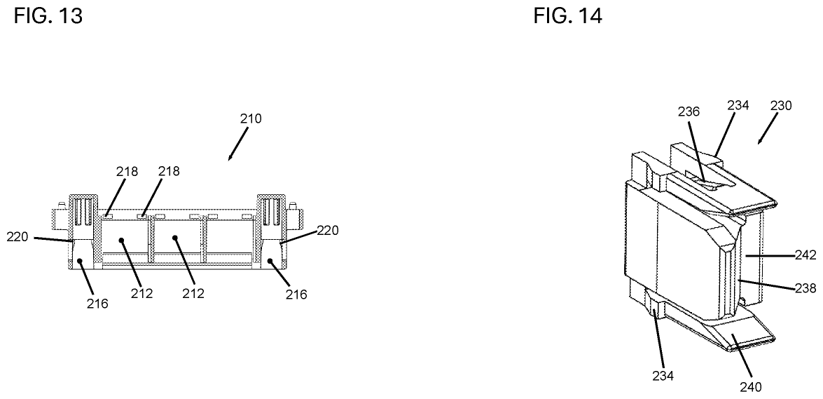

Referring to FIGS. 10-13, the stationary outer housing 210 is a laterally elongated structure configured to receive and retain multiple stationary inner connector units 270 in a side-by-side arrangement. The stationary outer housing 210 includes a plurality of connector unit receptacles 212 arranged in a linear series along the x-axis width of the stationary outer housing 210. Each connector unit receptacle 212 is sized and shaped to accommodate a corresponding stationary inner connector unit 270. Each connector unit receptacle 212 defines a polarity keyway 214. The polarity keyways 214 are positioned along a narrow side of each connector unit receptacle 212 to receive corresponding polarity keys on the stationary inner connector units 270, thereby ensuring proper orientation and alignment of the stationary inner connector units 270 when the stationary inner connector units 270 are inserted into the connector unit receptacles 212.

With continued reference to FIGS. 10-13, the stationary outer housing 210 includes slideways 216 on opposite sides of the connector unit receptacles 212. The slideways 216 extend along the z-axis length of the stationary outer housing 210 and are configured to receive sliders 230 therein. The slideways 216 provide channels within which the sliders 230 may move in a forward and rearward direction along the mating axis. Catches 220 are located within the slideways 216 for engaging the sliders 230 to retain the sliders 230 within the slideways 216 against the bias of slider springs 232. The engagement between the catches 220 and the latch hooks 234 prevents ejection of the sliders 230 from the slideways 216 while permitting controlled sliding movement of the sliders 230 during shutter actuation.

The stationary outer housing 210 further includes slots 218 formed along an upper surface of the stationary outer housing 210. The slots 218 may be positioned between adjacent connector unit receptacles 212 and are configured to receive U-shaped retention clips 260 that secure the stationary inner connector units 270 within the connector unit receptacles 212.

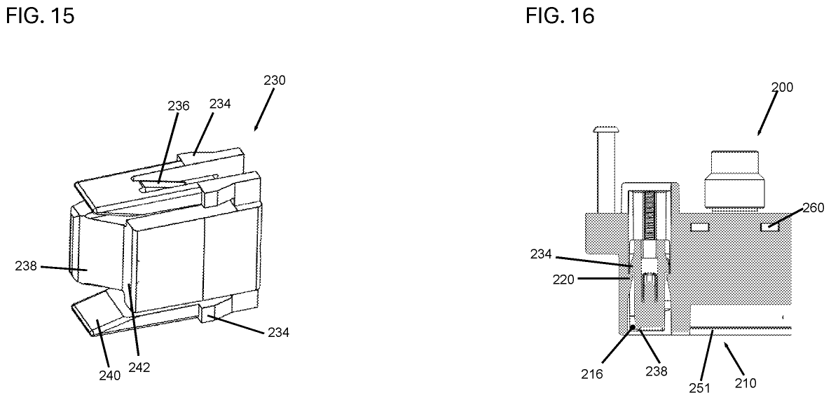

Referring to FIGS. 14-16, each slider 230 includes a pair of latch hooks 234 positioned at upper and lower locations on the slider 230. The latch hooks 234 are configured to engage the corresponding catches 220 on the stationary outer housing 210 to retain the slider 230 in the slideway 216 against the bias of the slider springs 232. The engagement between the latch hooks 234 and the catches 220 prevents ejection of the sliders 230 from the slideways 216 while permitting controlled sliding movement of the sliders 230 during shutter actuation.

Each slider 230 further includes shutter retainer tangs 236 configured to engage corresponding recesses on the stationary connector shutter plates 251 to connect the stationary connector shutter plates 251 to the sliders 230. The connection between the shutter retainer tangs 236 and the stationary connector shutter plates 251 is such that movement of the sliders 230 drives corresponding movement of the stationary connector shutter plates 251.

With continued reference to FIGS. 14-16, each slider 230 includes an x-axis alignment guide 238 comprising a chamfered leading surface. As will be explained in further detail below, the x-axis alignment guide 238 is configured to engage corresponding x-axis guide surfaces of the floating connector assembly 300 during a mating operation to facilitate alignment along the x-axis. In one or more embodiments, the x-axis alignment guide comprises a generally planar surface angled to slope inward along the x-axis as it extends rearward along the z-axis. Each slider 230 also includes a pair of opposing y-axis alignment guides 240. Each y-axis alignment guide 240 comprises a chamfered leading surface. In certain embodiments, each y-axis alignment guide comprises a generally planar surface angled to slope inward along the y-axis as it extends rearward along the z-axis. Like the x-axis alignment guide 238, the y-axis alignment guides 240 are configured to engage corresponding y-axis guide surfaces of the floating connector assembly 300 to facilitate alignment along the y-axis.

Each slider 230 further includes stops 242 positioned at a rear end of the x-axis alignment guide 238. Each stop 242 comprises a flat surface extending generally perpendicular to the z-axis. During mating operations, end features of the floating connector assembly 300 stop against the stops 242 after the floating connector assembly self-aligns with the stationary connector assembly 200 along the x-axis. Continued advancement of the floating connector assembly 300 pushes the sliders 230 rearward against the bias of the slider springs 232, thereby moving the stationary connector shutter plates 251 from the closed position to the open position.

As shown in FIG. 16, the sliders 230 are received within the slideways 216 of the stationary outer housing 210. The slider springs 232 are loaded between the sliders 230 and the stationary outer housing 210 to yieldably bias the sliders 230 in a forward direction along the z-axis. When the sliders 230 are pushed rearward against the bias of the slider springs 232 during a mating operation, the slider springs 232 compress and store energy. When the floating connector assembly 300 is withdrawn from the stationary connector assembly 200, the slider springs 232 release the stored energy to return the sliders 230 to the forward position, thereby moving the stationary connector shutter plates 251 from the open position back to the closed position.

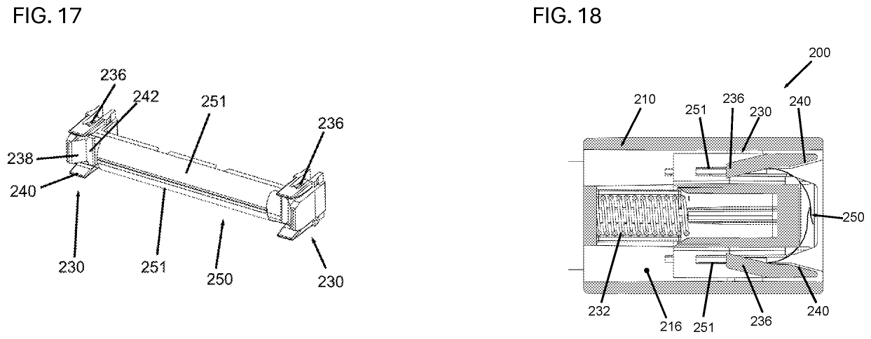

Referring to FIGS. 17 and 18, the stationary connector shutter 250 comprises a pair of stationary connector shutter plates 251 that extend laterally between the sliders 230 to cover the stationary inner connector units 270 when in a closed position. Each stationary connector shutter plate 251 engages corresponding shutter retainer tangs 236 on the sliders 230 to connect the stationary connector shutter plates 251 to the sliders 230. The connection between the shutter plates 251 and the shutter retainer tangs 236 is such that movement of the sliders 230 drives corresponding movement of the stationary connector shutter plates 251. When the sliders 230 are pushed rearward against the bias of the slider springs 232 during a mating operation, the stationary connector shutter plates 251 move from the closed position to an open position to expose the ferrules 282 of the stationary inner connector units 270. When the floating connector assembly 300 is withdrawn from the stationary connector assembly 200, the slider springs 232 return the sliders 230 to the forward position, thereby moving the stationary connector shutter plates 251 from the open position back to the closed position.

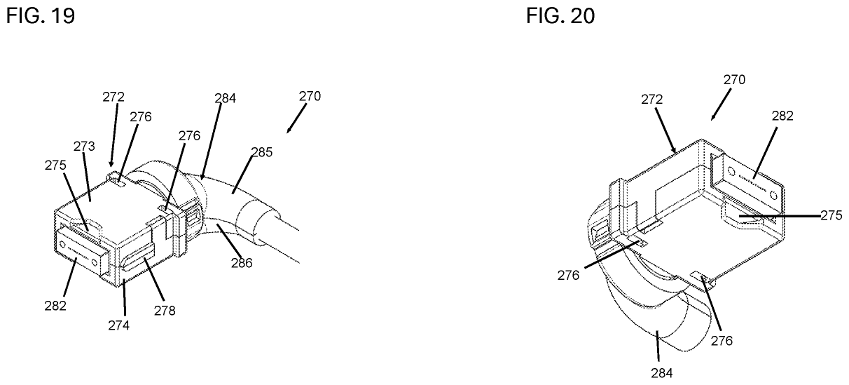

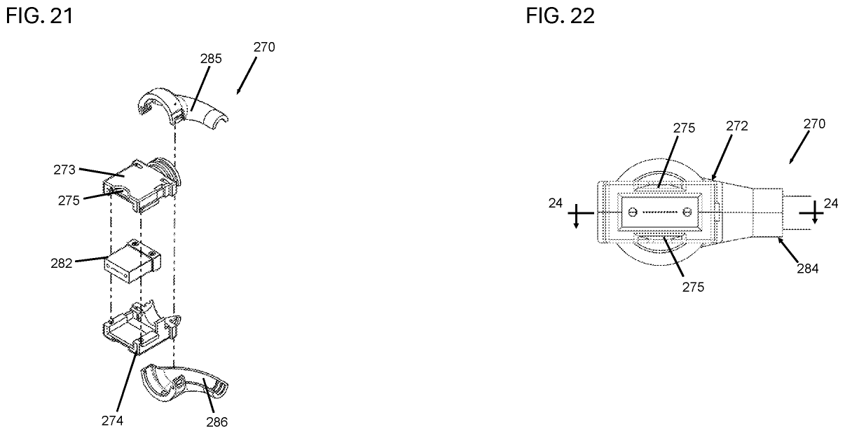

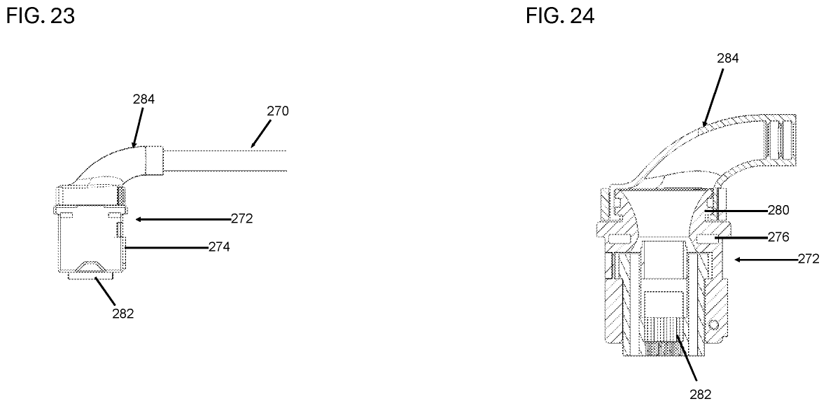

Referring to FIGS. 19-24, each stationary inner connector unit 270 includes an inner connector body 272. In the illustrated embodiment, the stationary inner connector unit 270 has a two-part clamshell construction. The two-part clamshell construction includes a first connector body part 273 and a second connector body part 274 that clasp together to form the inner connector body 272. The inner connector body 272 includes mating recesses 275 formed on broad sides thereof at the front end portion thereof. As will be explained in further detail below, the mating recesses 275 are configured to receive mating protrusions from the floating connector assembly 300 during a mating operation (sequentially after the stationary connector shutter 250 has been opened). The inner connector body 272 further includes clipping slots 276 configured to receive legs of the U-shaped retention clips 260. The U-shaped retention clips 260 are received in the slots 218 of the stationary outer housing 210 and the clipping slots 276 on the stationary inner connector units 270 to secure the stationary inner connector units 270 within the connector unit receptacles 212 of the stationary outer housing 210. As shown in FIG. 19, a polarity key 278 extends from a narrow side of the inner connector body 272. The polarity key 278 is configured to mate with a corresponding polarity keyway 214 in the connector unit receptacle 212 to ensure proper orientation of the stationary inner connector unit 270 when the stationary inner connector unit 270 is inserted into the stationary outer housing 210.

Each stationary inner connector unit 270 includes a ferrule 282 positioned at a leading end of the inner connector body 272. In one or more embodiments, the ferrule 282 may be an MT ferrule configured to establish optical connections with a corresponding ferrule of a floating inner connector unit 440. The ferrule 282 is supported within the inner connector body 272 by the first connector body part 273 and the second connector body part 274.

Each stationary inner connector unit 270 includes an integrated back post 280 extending from a trailing end of the inner connector body 272. The back post 280 provides a pathway for optical fibers and a mounting location for strain relief components. Each stationary inner connector unit 270 further includes an angled strain relief boot 284 extending from the back post 280. In the illustrated embodiment, the angled strain relief boot 284 comprises a two-part clamshell construction including a first boot part 285 and a second boot part 286 configured to be clasped together around the back post 280 to secure the angled strain relief boot to the connector body 272. The angled strain relief boot 284 is oriented at an angle relative to a longitudinal axis of the inner connector body 272, directing optical fiber cables away from the stationary inner connector unit 270 at an oblique angle to accommodate cable routing from the stationary connector assembly 200, e.g., cable routing in small spaces behind a backplane B.

In this embodiment, each stationary inner connector unit 270 is devoid of a ferrule spring. As will be explained in further detail below, the floating inner connector units 440 of the floating connector assembly 300 include ferrule springs that provide the spring force for maintaining optical contact between mated ferrule pairs. The absence of a ferrule spring in the stationary inner connector units 270 may reduce the footprint of the stationary connector assembly 200 while the ferrule springs of the floating inner connector units 440 provide the compliance and contact force for optical coupling.

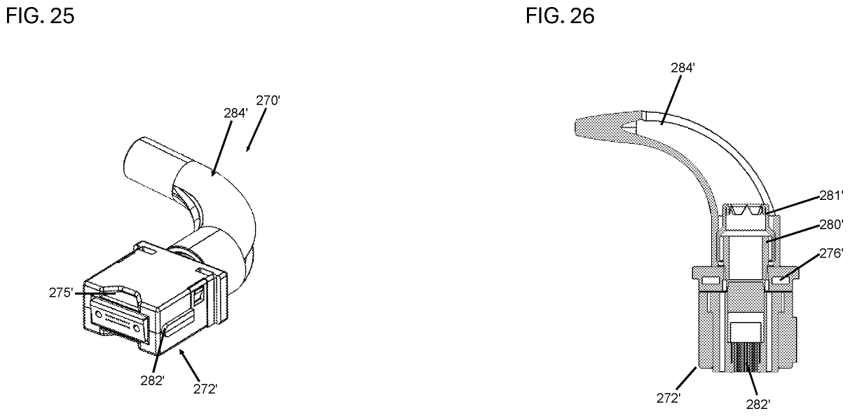

Referring to FIGS. 25 and 26, in an alternative embodiment, a stationary inner connector unit 270′ may include a strain relief boot 284′ having a one-piece construction rather than the two-part clamshell construction of the angled strain relief boot 284 described above. In the alternative embodiment, a crimp ring 281′ may be used to secure optical fibers to a back post 280′ of the stationary inner connector unit 270′, rather than the integrated back post and clamshell boot arrangement of the primary embodiment.

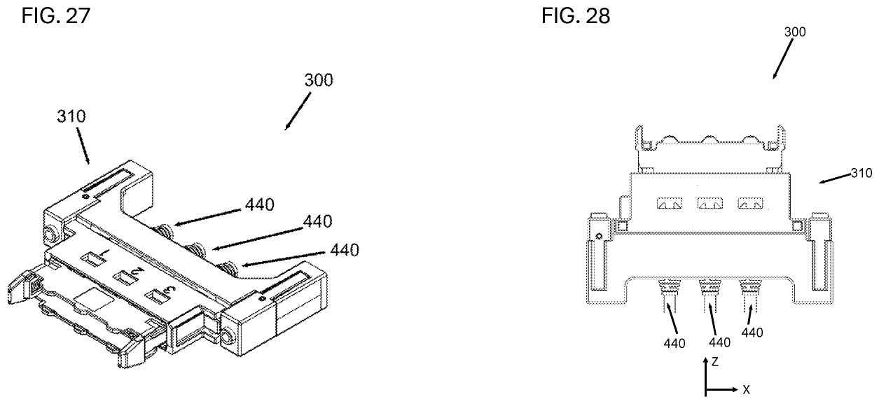

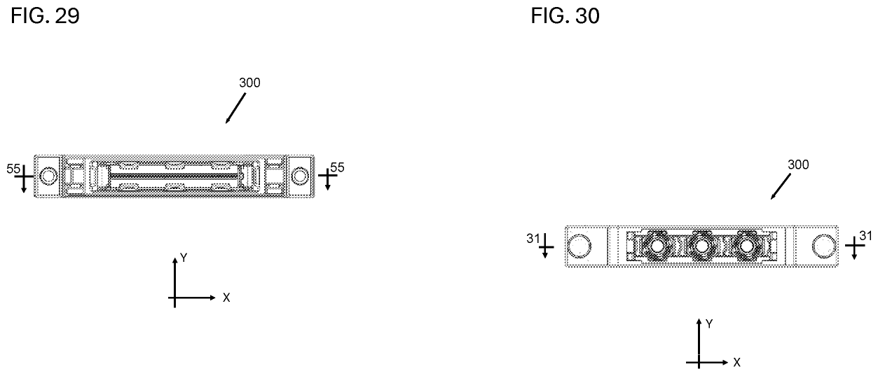

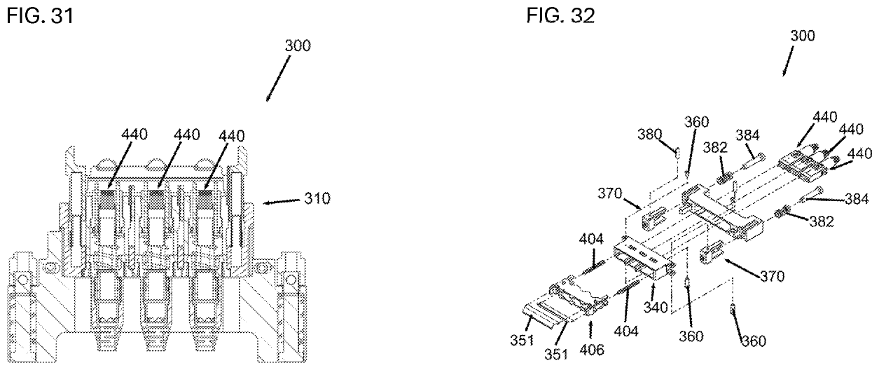

Referring to FIGS. 27-31, the floating connector assembly 300 comprises a floating outer housing assembly 310 (broadly, second outer housing) and a plurality of floating inner connector units 440 (broadly, second inner connector units). The floating outer housing assembly 310 provides the structural framework for the floating connector assembly 300 and is configured to receive and organize the various components of the assembly. The plurality of floating inner connector units 440 are received within inner connector receptacles of the floating outer housing assembly 310. As will be explained in further detail below, the floating outer housing assembly 310 comprises multiple housing members that enable the floating connector assembly 300 to move relative to a mounting structure in three degrees of freedom, including movement along the x-axis, movement along the y-axis, and movement along the z-axis. The three-axis floating capability provides blind mate compatibility, allowing the floating connector assembly 300 to self-align with the stationary connector assembly 200 during a mating operation.

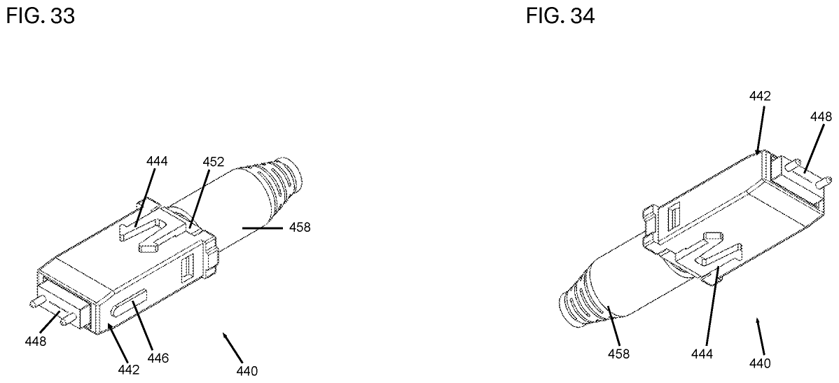

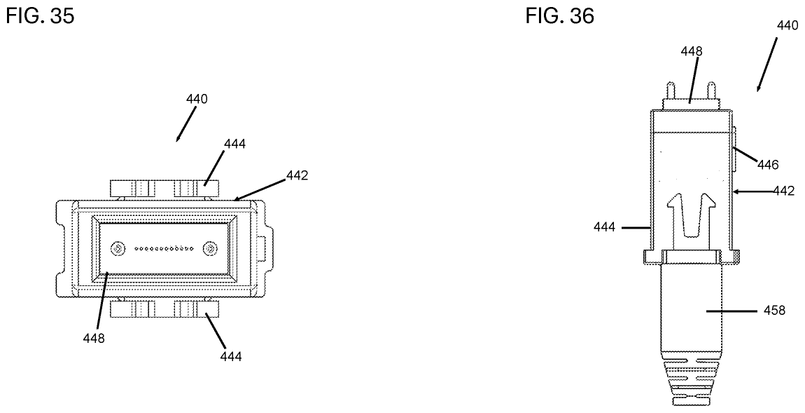

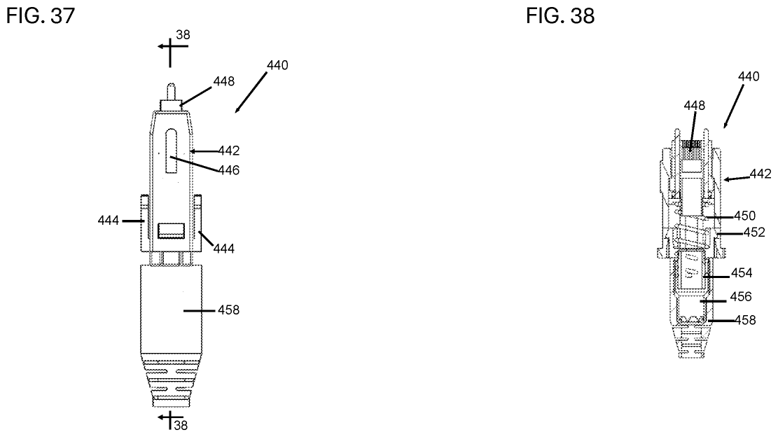

Referring to FIGS. 33-39, each floating inner connector unit 440 includes an inner connector body 442 that houses the internal components and provides structural support for the floating inner connector unit 440. The inner connector body 442 has a generally rectangular shape with a leading end portion and a trailing end portion. As shown in FIGS. 33-37, a pair of latch hooks 444 are positioned on broad sides of the inner connector body 442. The latch hooks 444 are configured to secure the floating inner connector unit 440 in place in the central housing member 340 of the floating outer housing assembly 310. A polarity key 446 extends from one narrow side of the inner connector body 442. The polarity key 446 ensures proper orientation of the floating inner connector unit 440 during assembly.

As shown in FIGS. 33-39, each floating inner connector unit 440 includes a ferrule 448 positioned at a leading end of the inner connector body 442. In one or more embodiments, the ferrule 448 may be an MT ferrule configured to establish optical connections with a corresponding ferrule 282 of a stationary inner connector unit 270. The ferrule 448 provides the optical interface for fiber optic connections between the floating connector assembly 300 and the stationary connector assembly 200.

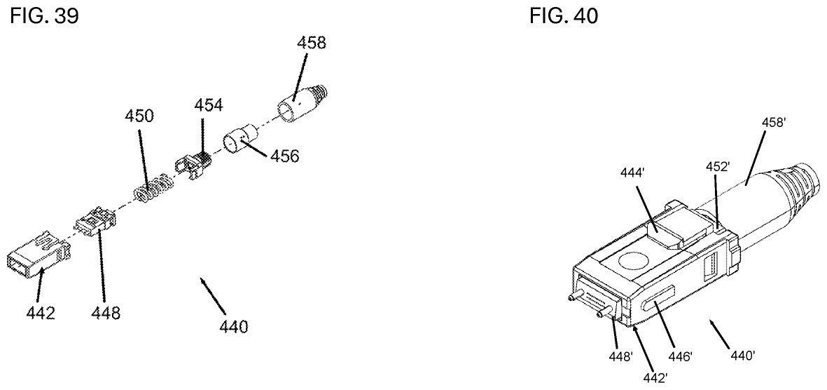

Referring to FIGS. 38 and 39, unlike the stationary inner connector units 270, each floating inner connector unit 440 includes a ferrule spring 450 positioned within the inner connector body 442. The ferrule spring 450 biases the ferrule 448 in a direction along the z-axis. The ferrule spring 450 provides the spring force for maintaining optical contact between mated ferrule pairs when the stationary connector assembly 200 and the floating connector assembly 300 are in a mated state. With continued reference to FIGS. 38 and 39, a spring push 452 is secured in the rear end portion of the inner connector body 442 to load the ferrule spring 450 against the ferrule 448. A back post 454 extends from a trailing end of the inner connector body 442 and provides a pathway for optical fibers and a mounting location for strain relief components.

As further shown in FIGS. 38 and 39, a crimp ring 456 is disposed around a portion of the back post 454 to secure optical fiber cables to the floating inner connector unit 440. A strain relief boot 458 is secured to the back post 454 at a trailing end of the floating inner connector unit 440. The strain relief boot 458 provides protection and strain relief for optical fibers extending from the floating inner connector unit 440.

In this embodiment, the ferrule springs 450 of the floating inner connector units 440 provide the compliance and contact force for optical coupling between the ferrules 448 of the floating inner connector units 440 and the ferrules 282 of the stationary inner connector units 270. The stationary inner connector units 270 are devoid of ferrule springs, and the ferrule springs 450 of the floating inner connector units 440 provide the spring force for both mating ferrule pairs.

Referring to FIG. 40, in an alternative embodiment, a floating inner connector unit 440′ may include an inner connector body 442′ having a latch hook 444′ with a different configuration than the latch hook 444 of the primary embodiment. Whereas the hooking features of the latch hook 444 project laterally outward along the x-axis in the previous embodiment, the hooking features of the latch hook 444′ project outward transversely along the y-axis in the illustrated embodiment. Various latch configurations are possible without departing from the scope of the disclosure. The floating inner connector unit 440′ is otherwise substantially the same as the floating inner connector unit 440. Hence, the floating inner connector unit 440′ comprises a polarity key 446′, a ferrule 448′, a spring push 452′, and a strain relief boot 458′ that function similarly to the corresponding components of the primary embodiment described above.

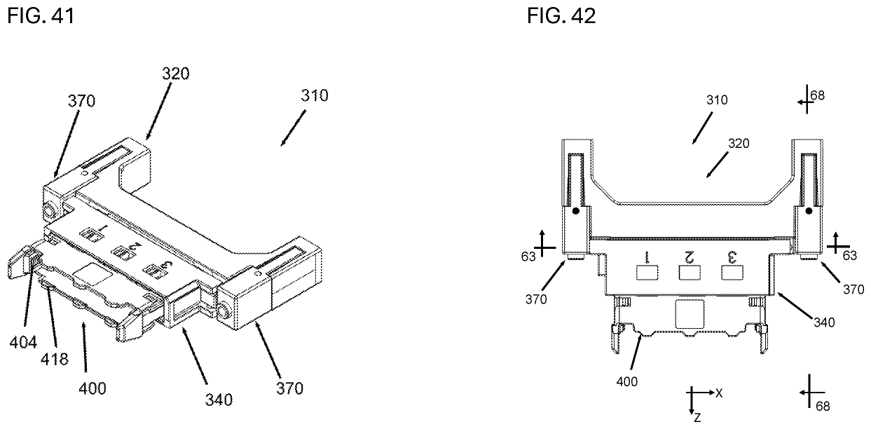

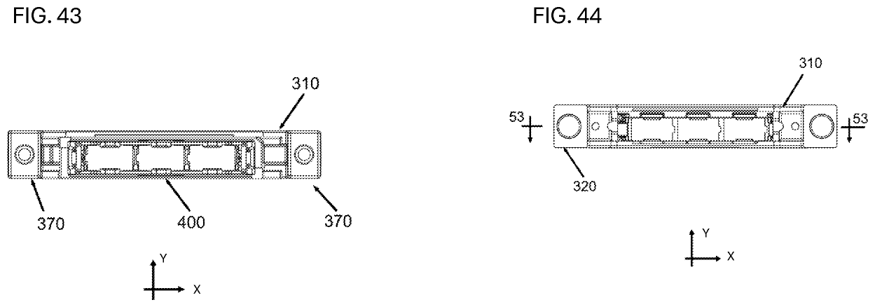

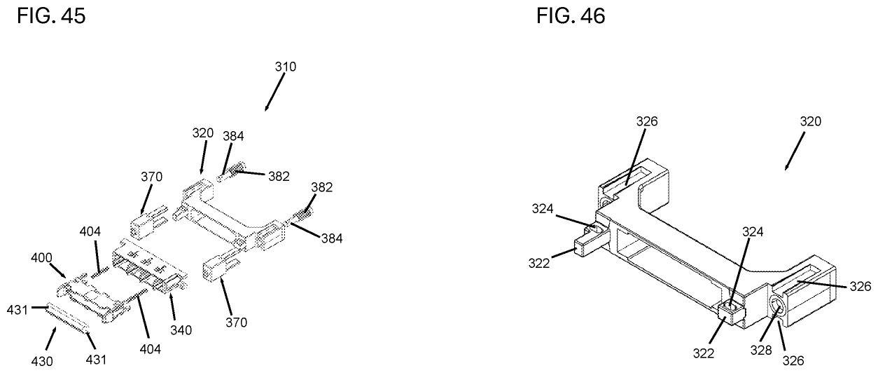

Referring to FIGS. 41-45, the floating outer housing assembly 310 comprises a pair of slide fixtures 370 (broadly, first housing members), a trailing housing member 320 (broadly, a second housing member), a central housing member 340 (broadly, a third housing member), float springs 382, pins 384, a slider housing 400, slider housing springs 404, and a floating connector shutter 430 comprising a pair of floating connector shutter plates 431. The slide fixtures 370 are configured to mount the floating connector assembly 300 to network equipment such as the chassis component C. As explained below, the central housing member 340 is configured to receive and retain the floating inner connector units 440. The trailing housing member 320 connects the central housing member 340 to the slide fixtures 370 in a manner that facilitates floating movement in a plane perpendicular to the z-axis. Further, the trailing housing member 320 has a spring loaded connection to the slide fixtures 370 such that it biases the central housing member 340 and the floating inner connector units 440 forward relative to the slide fixtures with sufficient force to ensure optical contact between mated ferrule pairs when the backplane connection system 100 is in a mated state. The slider housing 400 functions both as a slider for actuating the floating connector shutter 430 and as a self-aligning interface structure that operatively engages the x-axis alignment guides 238 and y-axis alignment guides 240 of the stationary connector assembly 200 during a mating operation.

Referring to FIG. 46, the trailing housing member 320 is a component of the floating outer housing assembly 310 that provides structural support and enables z-axis float capability for the floating connector assembly 300. The trailing housing member 320 has a generally rectangular configuration and includes extensions 322 positioned at a leading end thereof. The extensions 322 extend in a leading direction along the z-axis and are configured to interface with the central housing member 340.

Each extension 322 includes a fastener slot 324 elongated along the x-axis. The fastener slots 324 are configured to receive floating fasteners 360 that connect the trailing housing member 320 to the central housing member 340. The elongated configuration of the fastener slots 324 along the x-axis provides clearance that permits the central housing member 340 to move relative to the trailing housing member 320 along the lateral axis within a limited range of x-axis floating motion, thereby providing x-axis floating capability of the floating connector assembly 300.

With continued reference to FIG. 46, the trailing housing member 320 includes grooves 326 configured to receive slide arms 376, 378 of the slide fixtures 370 in a tongue-and-groove arrangement. In one or more embodiments, the grooves 326 have a dovetail cross-section that permits relative sliding movement between the slide fixtures 370 and the trailing housing member 320 along the z-axis while constraining movement in other directions. The tongue-and-groove arrangement between the grooves 326 and the slide arms 376, 378 prevents separation of the slide fixtures 370 from the trailing housing member 320 while enabling the z-axis float capability.

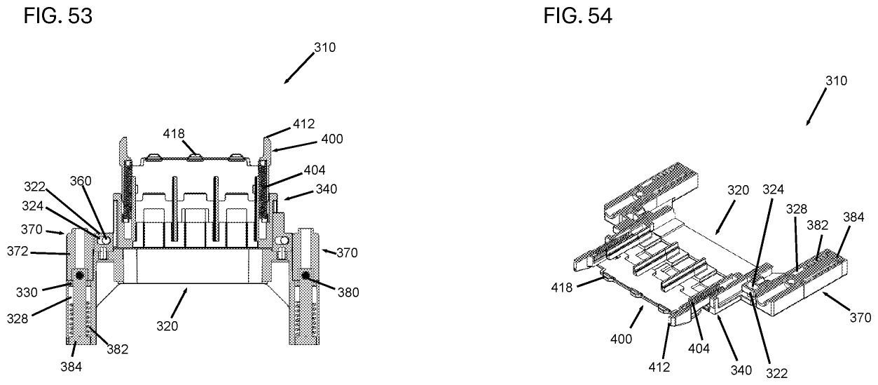

Referring to FIG. 53, the trailing housing member 320 further includes spring channels 328 formed between pairs of grooves 326. The spring channels 328 are configured to receive float springs 382 mounted on pins 384. Each spring channel 328 includes a seat 330 at a leading end thereof. The float springs 382 are loaded between the heads of the pins 384 and the seats 330 of the trailing housing member 320. The pins 384 protrude from the leading end of the spring channels 328 and are secured to the slide fixtures 370 by screws 380. This arrangement establishes a spring-loaded connection between the slide fixtures 370 and the trailing housing member 320, permitting the trailing housing member 320 to move relative to the slide fixtures 370 along the z-axis while the float springs 382 provide a biasing force.

Referring to FIGS. 47 and 48, each slide fixture 370 includes a fixture block 372 and a pair of slide arms extending from the fixture block 372. The fixture block 372 has a generally rectangular configuration and defines a screw hole 374 extending through the fixture block 372 in a direction along the y-axis. The screw hole 374 is configured to receive a screw 380 for securing a pin 384 to the fixture block 372.

A first slide arm 376 and a second slide arm 378 extend from the fixture block 372 in a trailing direction parallel to the z-axis. The first slide arm 376 and the second slide arm 378 are spaced apart from one another along the y-axis. The first slide arm 376 and the second slide arm 378 are configured to be received in the grooves 326 of the trailing housing member 320 in a tongue-and-groove arrangement. In one or more embodiments, the first slide arm 376 and the second slide arm 378 may have a complementary dovetail cross-section that corresponds to the dovetail cross-section of the grooves 326. The dovetail tongue-and-groove arrangement permits relative sliding movement between the slide fixtures 370 and the trailing housing member 320 along the z-axis while constraining movement in other directions and preventing separation of the slide fixtures 370 from the trailing housing member 320.

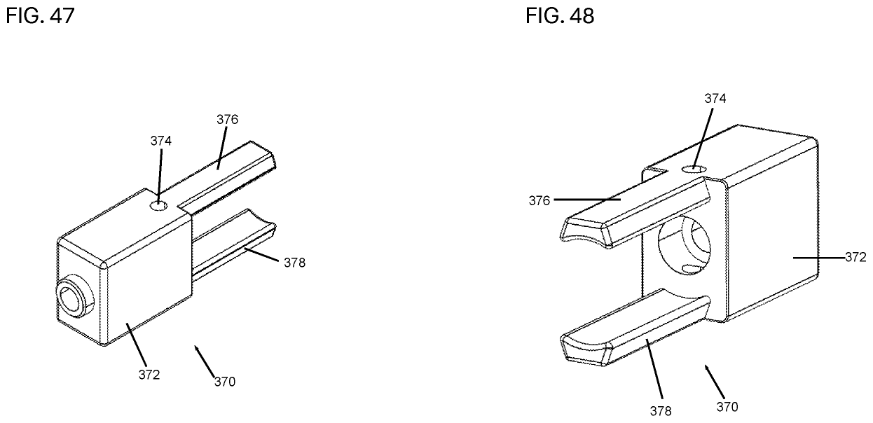

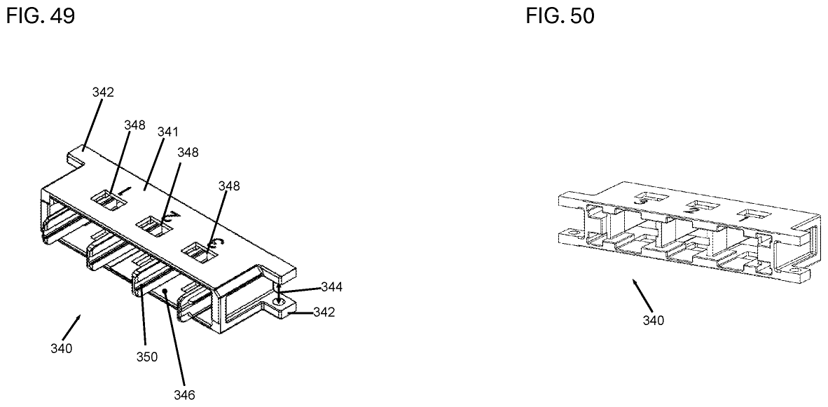

Referring to FIGS. 49 and 50, the central housing member 340 is a component of the floating outer housing assembly 310 that receives and retains the floating inner connector units 440. The central housing member 340 includes a main body 341 that defines the overall structure of the central housing member 340. The main body 341 has a generally rectangular configuration that is elongated along the x-axis.

With continued reference to FIGS. 49 and 50, pairs of tabs 342 extend laterally outward from a trailing end portion of the main body 341. The two pairs of tabs 342 are positioned at opposite ends of the central housing member 340 along the x-axis. Each pair of tabs 342 defines a gap 344 extending between the two tabs of the pair along the y-axis. The gaps 344 are configured to receive the extensions 322 of the trailing housing member 320 with clearance relative to the tabs 342 along the y-axis. As will be explained in further detail below, the clearance between the extensions 322 and the tabs 342 within the gaps 344 permits the central housing member 340 to move relative to the trailing housing member 320 along the y-axis within a limited range of y-axis floating motion.

The main body 341 defines a plurality of inner connector receptacles 346 arranged in a linear series along the x-axis width of the central housing member 340. Each inner connector receptacle 346 is sized and shaped to receive a corresponding floating inner connector unit 440. As shown in FIG. 49, catches 348 are associated with the inner connector receptacles 346. The catches 348 are configured to engage latch hooks 444 on the floating inner connector units 440 to secure the floating inner connector units 440 within the inner connector receptacles 346.

Each inner connector receptacle 346 further includes internal keyways 350 positioned along interior walls thereof. The internal keyways 350 are configured to receive corresponding polarity keys 446 on the floating inner connector units 440. The engagement between the internal keyways 350 and the polarity keys 446 ensures proper orientation and polarity alignment of the floating inner connector units 440 when the floating inner connector units 440 are inserted into the inner connector receptacles 346.

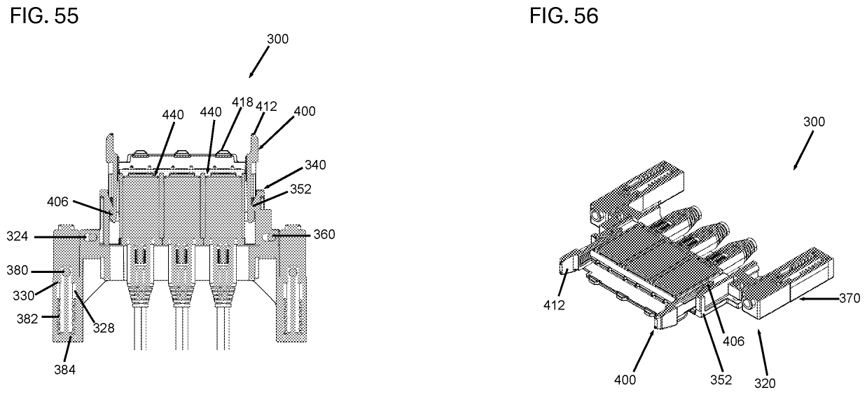

As shown in FIG. 55, the central housing member 340 further includes catches 352 configured to latch with the slider housing 400. The catches 352 retain the slider housing 400 within the central housing member 340 against the bias of the slider housing springs 404 while permitting controlled sliding movement of the slider housing 400 relative to the central housing member 340 during shutter actuation.

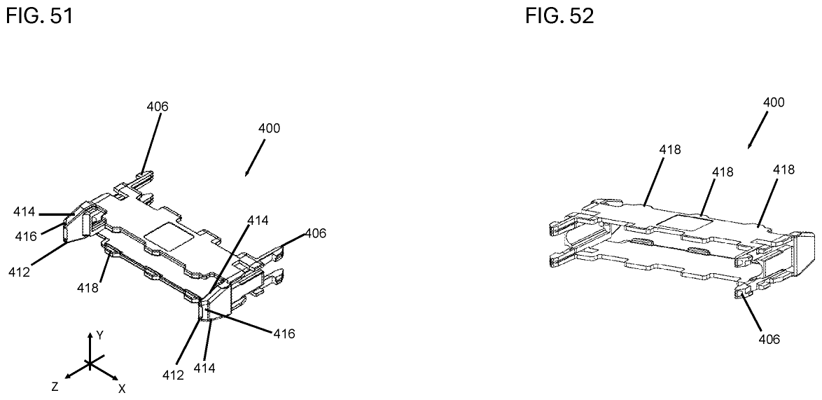

Referring to FIGS. 51 and 52, the slider housing 400 is configured to function both as a slider for actuating the floating connector shutter 430 and as a self-aligning interface structure that operatively engages alignment guides of the stationary connector assembly 200 during a mating operation. The slider housing 400 includes a trailing end portion and a leading end portion spaced apart along the z-axis. The slider housing 400 is configured to mount the pair of shutter plates 431 adjacent the leading end portion. The trailing end portion of the slider housing 400 is configured to be received in the central housing member 340. A pair of latch hooks 406 are positioned on the trailing end portion of the slider housing 400. The latch hooks 406 are configured to engage corresponding catches 352 on the central housing member 340 to retain the slider housing 400 within the central housing member 340 against the bias of the slider housing springs 404. The engagement between the latch hooks 406 and the catches 352 prevents ejection of the slider housing 400 from the central housing member 340 while permitting controlled sliding movement of the slider housing 400 relative to the central housing member 340 during shutter actuation.

With continued reference to FIGS. 51 and 52, a pair of guide fingers 412 extend from the leading end portion of the slider housing 400. The guide fingers 412 are configured to engage sliders 230 of the stationary connector assembly 200 during mating operations. Each guide finger 412 includes a pair of y-axis finger guides 414 positioned on opposing sides thereof. The y-axis finger guides 414 are configured to engage corresponding y-axis alignment guides 240 on the sliders 230 to facilitate alignment of the floating connector assembly 300 with the stationary connector assembly 200 along the y-axis. Each guide finger 412 further includes an x-axis finger guide 416 configured to engage a corresponding x-axis alignment guide 238 on the sliders 230 to facilitate alignment along the x-axis.

As further shown in FIGS. 51 and 52, a plurality of mating protrusions 418 are positioned on the slider housing 400 between the guide fingers 412. The mating protrusions 418 extend from the leading end portion of the slider housing 400 and are configured to engage corresponding mating recesses 275 on the inner connector bodies 272 of the stationary inner connector units 270 during a mating operation. The engagement between the mating protrusions 418 and the mating recesses 275 provides fine alignment along the y-axis after the guide fingers 412 have completed initial alignment with the sliders 230.

Referring to FIGS. 32 and 53-56, the floating outer housing assembly 310 comprises multiple housing members that are connected together to enable the three degrees of freedom movement capability of the floating connector assembly 300. The trailing housing member 320 is connected to the central housing member 340 by floating fasteners 360. The floating fasteners 360 pass through the fastener slots 324 of the extensions 322 on the trailing housing member 320 and engage the tabs 342 of the central housing member 340. The fastener slots 324 are elongated along the x-axis, and the gaps 344 between the tabs 342 extend along the y-axis. The elongated configuration of the fastener slots 324 provides clearance relative to the floating fasteners 360 that permits the central housing member 340 to move relative to the trailing housing member 320 along the x-axis. The y-axis clearance between the extensions 322 and the tabs 342 within the gaps 344 permits the central housing member 340 to move relative to the trailing housing member 320 along the y-axis. The combination of the fastener slots 324 and the gaps 344 cooperates to permit the central housing member 340 to move relative to the trailing housing member 320 along both the x-axis and the y-axis within a limited range of floating motion.

With continued reference to FIGS. 32 and 53, the slide fixtures 370 are connected to the trailing housing member 320 in spring-loaded relation by the float springs 382 and pins 384. Each pin 384 is received in a corresponding spring channel 328 of the trailing housing member 320. Each spring channel 328 includes a seat 330 at a leading end portion thereof. Each float spring 382 is mounted on a corresponding pin 384 and is loaded between the head of the pin 384 and the seat 330 of the trailing housing member 320. The pins 384 protrude from the leading end of the spring channels 328 and are secured to the fixture blocks 372 of the slide fixtures 370 by screws 380. The screws 380 pass through the screw holes 374 in the fixture blocks 372 to engage the pins 384. This arrangement establishes a spring-loaded connection between the slide fixtures 370 and the trailing housing member 320, permitting the trailing housing member 320 to move relative to the slide fixtures 370 along the z-axis while the float springs 382 provide a biasing force that urges the trailing housing member 320 in a forward direction along the z-axis.

As shown in FIGS. 55 and 56, the slider housing 400 is received within the central housing member 340. Slider housing springs 404 are loaded between the slider housing 400 and the central housing member 340 to yieldably bias the slider housing 400 in a forward direction along the z-axis. The catches 352 engage the latch hooks 406 on the slider housing 400 to retain the slider housing 400 within the central housing member 340 against the bias of the slider housing springs 404. The engagement between the latch hooks 406 and the catches 352 prevents ejection of the slider housing 400 from the central housing member 340 while permitting controlled sliding movement of the slider housing 400 relative to the central housing member 340 during shutter actuation. When the slider housing 400 is pushed rearward against the bias of the slider housing springs 404 during a mating operation, the floating connector shutter 430 moves with it and opens. The slider housing springs 404 compress and store energy. When the floating connector assembly 300 is withdrawn from the stationary connector assembly 200, the slider housing springs 404 release the stored energy to return the slider housing 400 to the forward position, thereby moving the floating connector shutter plates 431 from the open position back to the closed position.

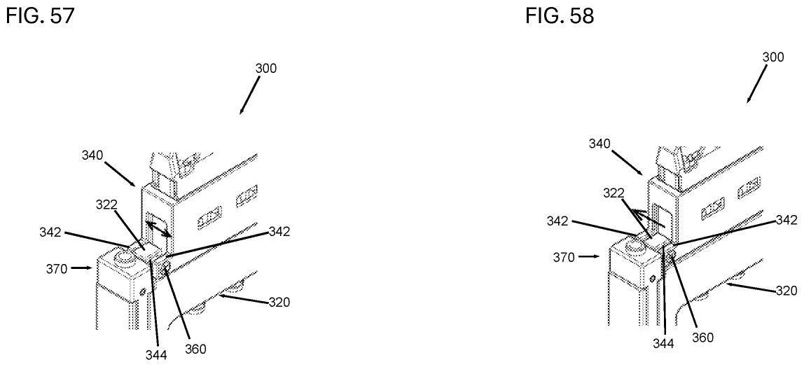

Referring to FIGS. 57-64, the x-y floating capability of the floating outer housing assembly 310 is illustrated. FIG. 57 shows the central housing member 340 in a neutral position relative to the trailing housing member 320, with the extensions 322 centered within the gaps 344 between the tabs 342. A double-ended arrow indicates the floating range of motion of the central housing member 340 along the y-axis.

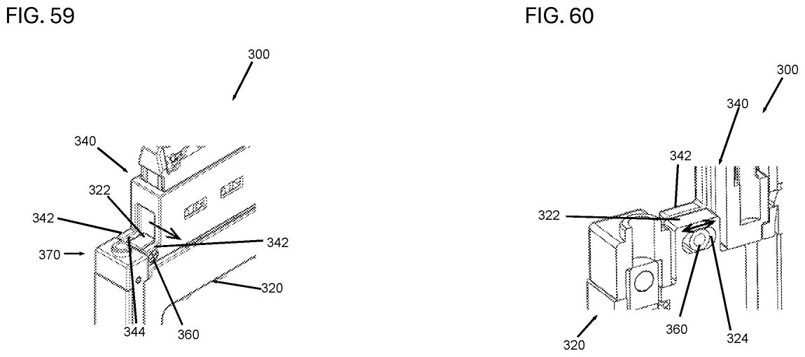

As shown in FIGS. 58 and 59, the central housing member 340 is shown at opposite ends of the floating range of motion along the y-axis. In FIG. 58, the extensions 322 are displaced toward one set of tabs 342 within the gaps 344, and in FIG. 59, the extensions 322 are displaced toward the opposite set of tabs 342.

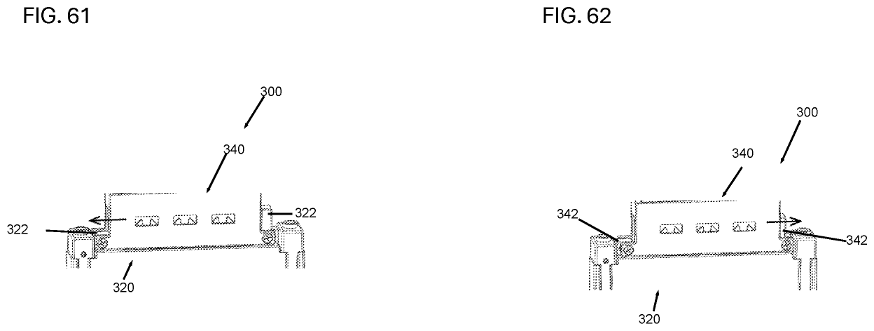

Referring to FIGS. 60-62, the floating range of motion of the central housing member 340 along the x-axis is illustrated. FIG. 60 shows the floating fasteners 360 within the fastener slots 324, with a double-ended arrow indicating the x-axis floating range of motion. FIG. 61 shows the central housing member 340 at one end of the floating range of motion along the x-axis, and FIG. 62 shows the central housing member 340 at the opposite end.

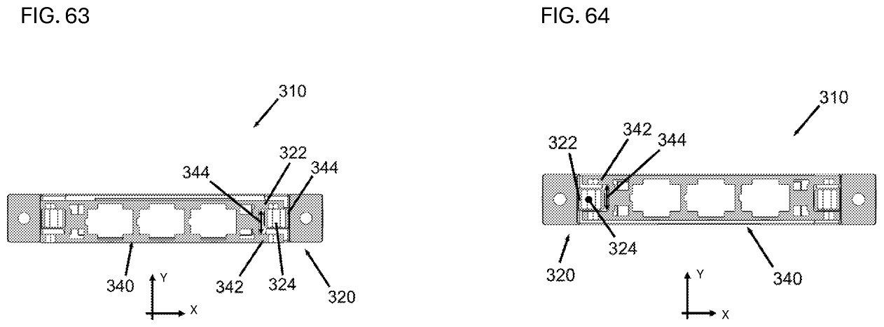

As further shown in FIGS. 63 and 64, the x-axis clearance provided by the fastener slots 324 and the y-axis clearance provided by the gaps 344 cooperate to permit the central housing member 340 to float in any direction within the x-y plane relative to the trailing housing member 320. FIG. 63 shows the central housing member 340 at one corner position of the floating range of motion in the x-y plane, and FIG. 64 shows the central housing member 340 at a diagonally opposite corner position.

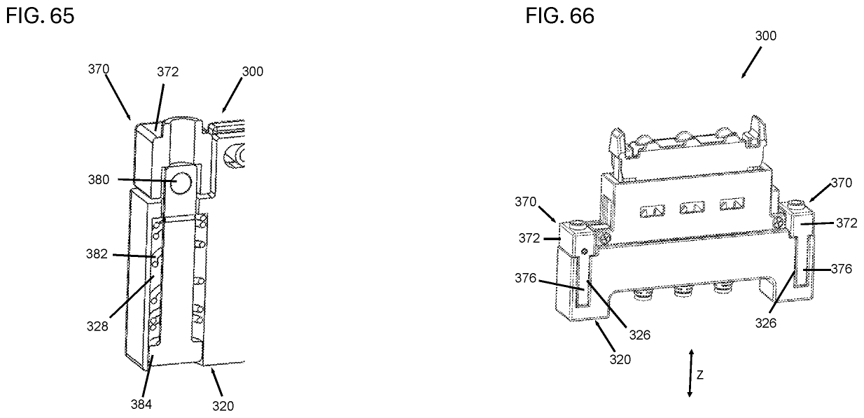

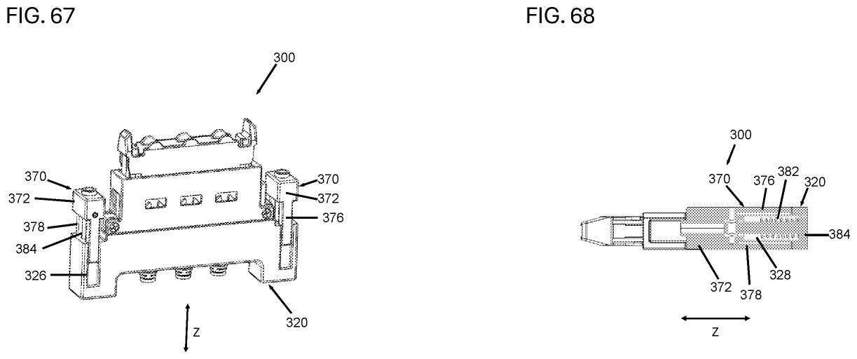

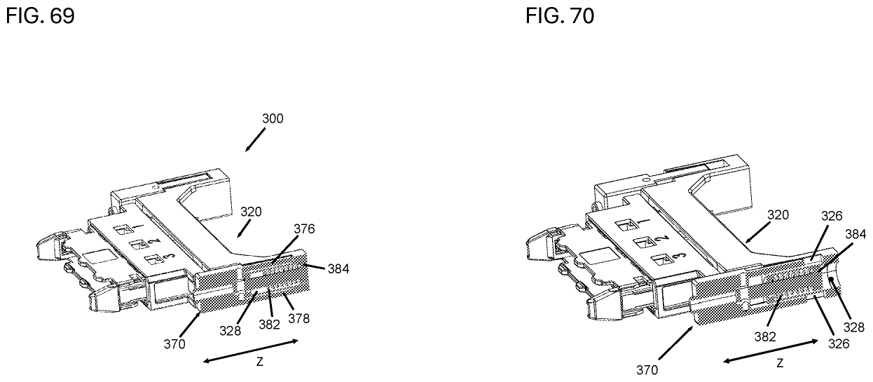

Referring to FIGS. 65-70, the z-axis floating capability of the floating outer housing assembly 310 is illustrated. FIG. 65 shows the spring-loaded connection between the slide fixtures 370 and the trailing housing member 320, with the float springs 382 on the pins 384 received in the spring channels 328 and loaded against the seats 330. FIGS. 66 and 69 show the float springs 382 in a fully extended state biasing the trailing housing member 320 to a forward-most position along the z-axis range of floating motion relative to the slide fixtures 370. FIGS. 67 and 70 show the float springs 382 in a compressed state with the trailing housing member 320 at a rearward-most position along the z-axis range of motion relative to the slide fixtures 370. The dovetail tongue-and-groove arrangement between the slide arms 376, 378 and the grooves 326 constrains the relative movement to the z-axis direction while preventing separation of the slide fixtures 370 from the trailing housing member 320.

As further shown in FIGS. 68-70, the z-axis floating capability accommodates variations in the z-axis height of the contact position during mating operations. When the floating connector assembly 300 mates with the stationary connector assembly 200, the float springs 382 compress as the trailing housing member 320 moves in the trailing direction relative to the slide fixtures 370, maintaining the biasing force that urges the ferrules 448 of the floating inner connector units 440 into contact with the ferrules 282 of the stationary inner connector units 270.

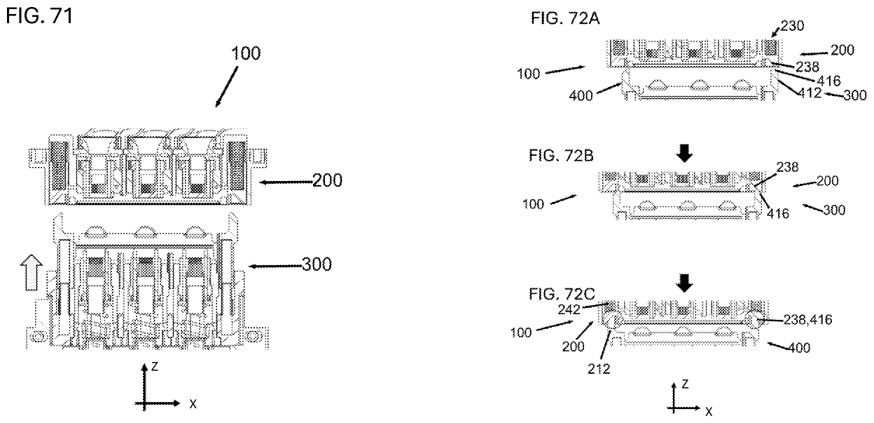

Referring to FIGS. 71 and 72A-72C, the initial stages of a mating sequence between the floating connector assembly 300 and the stationary connector assembly 200 are illustrated. FIG. 71 shows the floating connector assembly 300 approaching the stationary connector assembly 200 along the z-axis, with the guide fingers 412 of the slider housing 400 positioned to engage the sliders 230 of the stationary connector assembly 200.

As shown in FIG. 72A, the floating connector assembly 300 advances toward the stationary connector assembly 200, with the x-axis finger guides 416 on the guide fingers 412 approaching the x-axis alignment guides 238 on the sliders 230. At this stage, the shutters of both connector assemblies remain in their closed positions.

FIG. 72B illustrates the guide fingers 412 making initial contact with the sliders 230. The x-axis finger guides 416 engage the chamfered leading surfaces of the x-axis alignment guides 238. The chamfered surfaces of the x-axis alignment guides 238 slope inward along the x-axis as the surfaces extend rearward along the z-axis. This engagement initiates lateral repositioning of the floating connector assembly 300 relative to the stationary connector assembly 200. The x-axis floating capability of the floating connector assembly 300, provided by the clearance between the floating fasteners 360 and the fastener slots 324, permits the central housing member 340 and floating inner connector units 440 to shift laterally relative to the trailing housing member 320 as the chamfered surfaces guide the floating connector assembly 300 into alignment along the x-axis.

With continued reference to FIG. 72C, the x-axis alignment is completed as the x-axis finger guides 416 traverse the chamfered surfaces of the x-axis alignment guides 238 and come to rest on the stops 242 of the sliders 230. At this point, the floating connector assembly 300 is centered with respect to the stationary connector assembly 200 along the x-axis. The stops 242 provide flat surfaces extending generally perpendicular to the z-axis against which the guide fingers 412 bear. Continued forward movement of the floating connector assembly 300 from this position causes the guide fingers 412 to push the sliders 230 rearward against the bias of the slider springs 232, thereby initiating actuation of the stationary connector shutter 250.

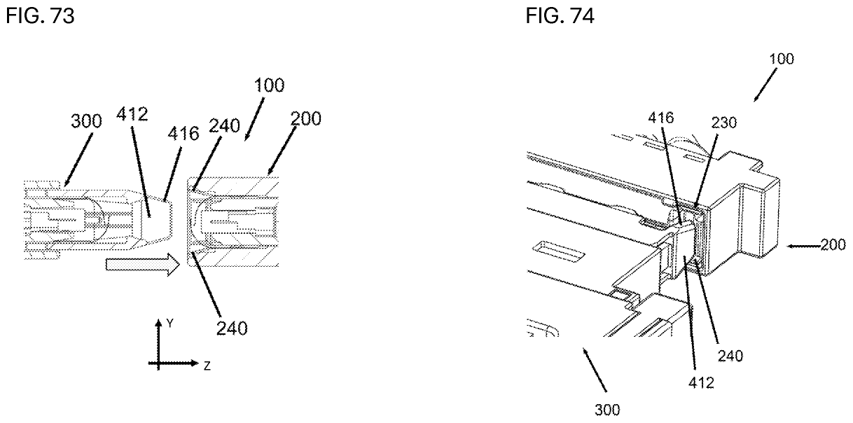

Referring to FIGS. 73 and 74, the y-axis alignment of the floating connector assembly 300 with the stationary connector assembly 200 occurs in conjunction with the x-axis alignment described above. As the floating connector assembly 300 advances toward the stationary connector assembly 200, the y-axis finger guides 414 on the guide fingers 412 engage the y-axis alignment guides 240 on the sliders 230. Each y-axis alignment guide 240 comprises a chamfered leading surface that slopes inward along the y-axis as the surface extends rearward along the z-axis. The engagement between the y-axis finger guides 414 and the chamfered surfaces of the y-axis alignment guides 240 initiates transverse repositioning of the floating connector assembly 300 relative to the stationary connector assembly 200.

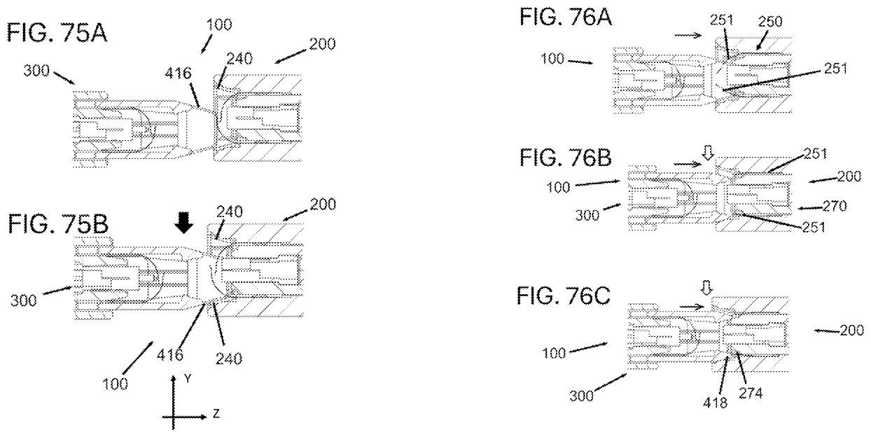

Referring to FIGS. 75A and 75B, the y-axis floating capability of the floating connector assembly 300, provided by the clearance between the extensions 322 and the tabs 342 within the gaps 344, permits the central housing member 340 and the floating inner connector units 440 to shift transversely relative to the trailing housing member 320 as the chamfered surfaces of the y-axis alignment guides 240 guide the floating connector assembly 300 into alignment along the y-axis. At this stage of the mating sequence, the stationary connector shutter 250 and the floating connector shutter 430 remain in their respective closed positions.

With continued reference to FIGS. 75A and 75B, as the floating connector assembly 300 continues to advance toward the stationary connector assembly 200, the guide fingers 412 traverse the chamfered surfaces of the y-axis alignment guides 240 until the guide fingers 412 come to rest on the stops 242 of the sliders 230. The stops 242 comprise flat surfaces extending generally perpendicular to the z-axis. When the guide fingers 412 rest on the stops 242, the floating connector assembly 300 is centered with respect to the stationary connector assembly 200 along both the x-axis and the y-axis.

Referring to FIGS. 76A-76C, once the guide fingers 412 rest on the stops 242, continued forward movement of the floating connector assembly 300 causes the guide fingers 412 to push the sliders 230 rearward against the bias of the slider springs 232. The rearward movement of the sliders 230 drives corresponding movement of the stationary connector shutter plates 251, moving the stationary connector shutter 250 from the closed position to the open position to expose the ferrules 282 of the stationary inner connector units 270.

As further shown in FIGS. 76A-76C, the mating protrusions 418 on the slider housing 400 engage the mating recesses 275 on the inner connector bodies 272 of the stationary inner connector units 270 as the floating connector assembly 300 advances. Note, however, that the sequence ensures that the stationary connector shutter 250 opens before the mating protrusions 418 reach the mating recesses. This ensures that the stationary connector shutter 250 does not interfere with engagement between the mating protrusions 418 and the mating recesses 275. The engagement between the mating protrusions 418 and the mating recesses 275 provides fine alignment along the y-axis after the guide fingers 412 have completed initial alignment with the sliders 230. At this stage, the floating connector shutter 430 still has not opened. Hence, it can be seen that the stationary connector shutter 250 opens before the floating connector shutter 430 opens, such that the ferrules 282 of the stationary inner connector units 270 are exposed while the ferrules 448 of the floating inner connector units 440 remain covered by the floating connector shutter plates 431.

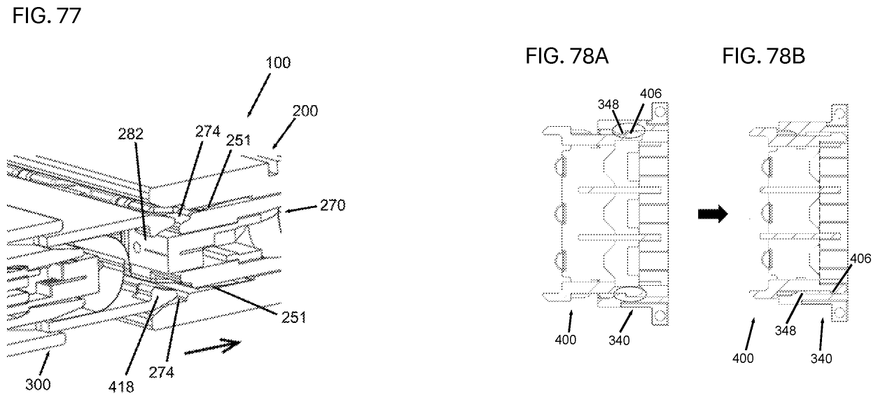

Referring to FIGS. 77-79C, the second stage of the sequential shutter actuation is illustrated. As shown in FIG. 77, the stationary connector shutter 250 has moved to the open position to expose the ferrules 282 of the stationary inner connector units 270, while the floating connector shutter 430 remains in the closed position covering the ferrules 448 of the floating inner connector units 440. At this stage, the mating protrusions 418 on the slider housing 400 are received within the mating recesses 275 on the inner connector bodies 272 of the stationary inner connector units 270. The engagement between the mating protrusions 418 and the mating recesses 275 has ensured fine alignment along the y-axis, completing the centering of the floating connector assembly 300 with respect to the stationary connector assembly 200.

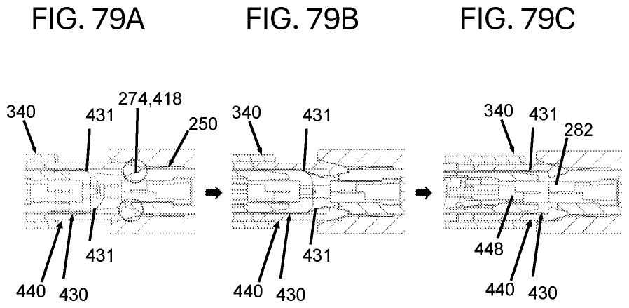

With continued reference to FIGS. 79A-79C, as the floating connector assembly 300 continues to advance toward the stationary connector assembly 200, the central housing member 340 moves forward relative to the slider housing 400. The slider housing springs 404 loaded between the slider housing 400 and the central housing member 340 compress as the central housing member 340 advances. The compression of the slider housing springs 404 causes the slider housing 400 to move rearward relative to the central housing member 340.

As further shown in FIGS. 79A-79C, the floating connector shutter plates 431 are connected to the slider housing 400 such that rearward movement of the slider housing 400 relative to the central housing member 340 drives corresponding movement of the floating connector shutter plates 431. As the slider housing 400 moves rearward, the floating connector shutter plates 431 move from the closed position toward the open position. FIG. 79B shows the floating connector shutter plates 431 in an intermediate position as the slider housing 400 moves rearward relative to the central housing member 340. FIG. 79C shows the floating connector shutter plates 431 in the fully open position, exposing the ferrules 448 of the floating inner connector units 440.

With the floating connector shutter plates 431 in the open position, the ferrules 448 of the floating inner connector units 440 are brought into contact with the ferrules 282 of the stationary inner connector units 270 to establish the optical connection. The ferrule springs 450 within the floating inner connector units 440 bias the ferrules 448 toward the ferrules 282 of the stationary inner connector units 270, providing the contact force for optical coupling between the mated ferrule pairs.

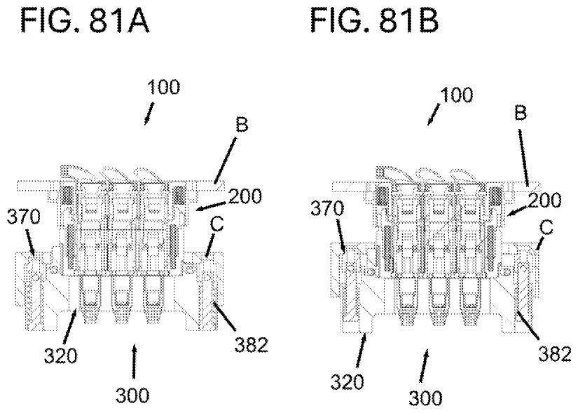

Referring to FIGS. 80A, 80B, 81A, and 81B, the arrangement of spring forces in the backplane connection system 100 is configured to achieve and maintain optical coupling at the ferrules 282, 448 when the stationary connector assembly 200 and the floating connector assembly 300 are in a mated state. The float springs 382 provide a cumulative float spring force F2+F2 that biases the trailing housing member 320 toward the stationary connector assembly 200. The ferrule springs 450 of the plurality of floating inner connector units 440 provide an aggregate ferrule spring force F1+F1+F1 that biases the ferrules 448 toward the ferrules 282 of the stationary inner connector units 270. The cumulative float spring force F2+F2 exceeds the aggregate ferrule spring force F1+F1+F1. In one or more embodiments, the float springs 382 may provide a cumulative float spring force F2+F2 of approximately 34 N, such as when two float springs 382 each provide approximately 17 N of spring force. The ferrule springs 450 may have an aggregate ferrule spring force F1+F1+F1 of approximately 30 N, such as when three floating inner connector units 440 each include a ferrule spring 450 providing approximately 10 N of spring force.

As further shown in FIGS. 81A and 81B, the arrangement in which the cumulative float spring force F2+F2 exceeds the aggregate ferrule spring force F1+F1+F1 ensures that the float springs 382 bias the trailing housing member 320 toward the stationary connector assembly 200 such that the ferrule springs 450 of the plurality of floating inner connector units 440 remain loaded when the stationary connector assembly 200 and the floating connector assembly 300 are in the mated state. In the illustrated embodiment, the float springs 382 may be compressed up to approximately 4 mm during the mating operation and still provide the desired spring load. When the float springs 382 are loaded, the driving force on the trailing housing member 320 is passed through to the central housing member 340 and to the floating inner connector units 440 to load the ferrule springs 450 and maintain optical contact between the ferrule end faces of the ferrules 282, 448. The slide fixtures 370 may be fixed to the chassis component C while the float springs 382 remain in the compressed state, thereby maintaining proper optical contact between the mated ferrule pairs.

A number of implementations have been described. Nevertheless, it will be understood that various modifications may be made without departing from the spirit and scope of the disclosure. Accordingly, other implementations are within the scope of the following claims.

1. A backplane optical fiber connection system, the backplane optical fiber connection system comprising:
a first connector assembly including:
a first outer housing;
a plurality of first inner connector units received in the first outer housing, each first inner connector unit including a ferrule; and
a first shutter movable between a closed position and an open position; and
a second connector assembly configured to mate with the first connector assembly, the second connector assembly including:
a second outer housing;
a plurality of second inner connector units received in the second outer housing, each second inner connector unit including a ferrule; and
a second shutter movable between a closed position and an open position;
wherein the first connector assembly and the second connector assembly are configured such that, during a mating operation in which the first connector assembly and the second connector assembly are brought together to establish an optical connection between the ferrules of the first inner connector units and the ferrules of the second inner connector units, the first shutter moves from the closed position to the open position before the second shutter moves from the closed position to the open position.

2. The backplane optical fiber connection system of claim 1, wherein the first connector assembly comprises a first spring-loaded slide actuator configured to slide to move the first shutter from the closed position to the open position when pressed proximally with a first force and the second connector assembly comprises a second spring-loaded slide actuator configured to slide to move the first shutter from the closed position to the open position when pressed proximally with a second force, the first force being less than the second force.

3. The backplane connection system of claim 1, wherein the first outer housing includes a pair of slideways on opposite sides of the first inner connector units, and wherein the first connector assembly further includes a pair of sliders received in the slideways and a pair of slider springs loaded between the sliders and the first outer housing to yieldably bias the sliders in a forward direction, the first shutter being connected to the sliders such that rearward movement of the sliders against the bias of the slider springs moves the first shutter from the closed position to the open position.

4. The backplane optical fiber connection system of claim 3, wherein each slider includes latch hooks that engage corresponding catches on the first outer housing to retain the slider in the slideway against the bias of the slider springs.

5. The backplane optical fiber connection system of claim 3, wherein the second connector assembly includes a slider housing having a leading end portion comprising guide fingers, the guide fingers being configured to engage the sliders and push the sliders rearward against the bias of the slider springs during the mating operation to move the first shutter from the closed position to the open position.

6. The backplane optical fiber connection system of claim 5, wherein the second outer housing includes another housing member in which the slider housing is received, and slider housing springs loaded between the slider housing and the other housing member to yieldably bias the slider housing in a forward direction, the second shutter being connected to the slider housing such that rearward movement of the slider housing relative to the other housing member against the bias of the slider housing springs moves the second shutter from the closed position to the open position.

7. The backplane optical fiber connection system of claim 5, wherein each slider includes an x-axis alignment guide comprising a chamfered leading surface and a pair of opposing y-axis alignment guides comprising chamfered leading surfaces, and wherein each guide finger includes an x-axis finger guide configured to engage the x-axis alignment guide and a pair of opposing y-axis finger guides configured to engage the y-axis alignment guides, such that the guide fingers align the second connector assembly with respect to the first connector assembly before the first shutter moves from the closed position to the open position.

8. A backplane optical fiber connection system for making a blind mate optical connection to a backplane of fiber optic network equipment, the backplane optical fiber connection system comprising:
a stationary connector assembly configured to be mounted adjacent the backplane of the fiber optic network equipment, the stationary connector assembly comprising:
a stationary outer housing; and
a plurality of stationary inner connector units received in the stationary outer housing, each stationary inner connector unit including a ferrule; and
a floating connector assembly configured to mate with the stationary connector assembly, the floating connector assembly including:
a floating outer housing assembly including a first housing member and a second housing member, the second housing member being movable relative to the first housing member along a mating axis to provide float along the mating axis;
a plurality of floating inner connector units received in the floating outer housing assembly, each floating inner connector unit including a ferrule and a ferrule spring biasing the ferrule in a direction along the mating axis, the ferrule springs of the plurality of floating inner connector units having an aggregate ferrule spring force; and
at least one float spring loaded between the first housing member and the second housing member, the at least one float spring having a cumulative spring force greater than the aggregate ferrule spring force;
wherein the at least one float spring biases the second housing member toward the stationary connector assembly such that the ferrule springs of the plurality of floating inner connector units remain loaded when the stationary connector assembly and the floating connector assembly are in a mated state.

9. The backplane optical fiber connection system of claim 8, wherein the first housing member comprises a slide fixture including a fixture block and a pair of slide arms extending from the fixture block, and wherein the second housing member comprises a trailing housing member including grooves that receive the slide arms in a tongue-and-groove arrangement permitting relative sliding movement between the slide fixture and the trailing housing member along the mating axis.

10. The backplane optical fiber connection system of claim 9, wherein the at least one float spring is mounted on a pin received in a spring channel of the trailing housing member, the at least one float spring being loaded between the pin and a seat of the trailing housing member, and wherein the pin is secured to the fixture block.

11. The backplane optical fiber connection system of claim 10, wherein the grooves of the trailing housing member have a dovetail cross-section and the slide arms have a complementary dovetail cross-section.

12. The backplane optical fiber connection system of claim 8, wherein each ferrule of the floating inner connector units is an MT ferrule.

13. The backplane optical fiber connection system of claim 8, wherein each floating inner connector unit further includes a spring push positioned between the ferrule spring and a back post of the floating inner connector unit.

14. The backplane optical fiber connection system of claim 8, wherein the floating outer housing assembly further includes a central housing member connected to the second housing member and defining a plurality of inner connector receptacles, the plurality of floating inner connector units being received in inner connector receptacles of the central housing member.

15. A backplane optical fiber connection system, the backplane optical fiber connection system comprising:
a stationary connector assembly including a stationary outer housing and a plurality of stationary inner connector units received in the stationary outer housing; and
a floating connector assembly configured to mate with the stationary connector assembly by movement toward the stationary connector along a mating axis, the floating connector assembly including:
a floating outer housing assembly comprising:
a trailing housing member;
a central housing member connected to the trailing housing member by floating fasteners that permit the central housing member to move relative to the trailing housing member in a plane perpendicular to the mating axis; and
at least one slide fixture connected to the trailing housing member in spring-loaded relation by at least one float spring that permits the trailing housing member to move relative to the slide fixture along the mating axis;
whereby the central housing member has at least three degrees of freedom of movement relative to the slide fixture including movement along the mating axis, movement along a lateral axis perpendicular to the mating axis, and movement along a transverse axis perpendicular to both the mating axis and the first lateral axis.

16. The backplane optical fiber connection system of claim 15, wherein the floating connector assembly comprises floating fasteners connecting the trailing housing member to the central housing member, the trailing housing member comprises extensions having fastener slots elongated along the lateral axis, the central housing member comprising tabs defining gaps along the transverse axis, the extensions received in the gaps with clearance relative to the tabs along the transverse axis and the floating fasteners received in the fastener slots with clearance relative to the extensions along the lateral axis such that the fastener slots and the gaps cooperate to permit the central housing member to move relative to the trailing housing member along both the lateral axis and the transverse axis.

17. The backplane optical fiber connection system of claim 15, wherein the at least one slide fixture includes a fixture block and a pair of slide arms extending from the fixture block parallel to the mating axis, and wherein the trailing housing member includes grooves that receive the slide arms to permit relative sliding movement between the slide fixture and the trailing housing member along the mating axis.

18. The backplane optical fiber connection system of claim 17, wherein the grooves have a dovetail cross-section and the slide arms have a complementary dovetail cross-section.

19. The backplane optical fiber connection system of claim 15, wherein the floating connector assembly further includes a slider housing received in the central housing member and biased in a forward direction along the mating axis, the slider housing including guide fingers at a leading end portion thereof configured to engage the stationary connector assembly during a mating operation to align the central housing member with the stationary outer housing.

20. The backplane optical fiber connection system of claim 19, wherein the floating connector assembly further includes a pair of floating connector shutter plates connected to the slider housing such that rearward movement of the slider housing relative to the central housing member moves the floating connector shutter plates from a closed position to an open position.
